(19) United States
(12) Patent Application Publication
(10) Pub. No.: US 2008/0251104 A1
(43) Pub. Date: Oct. 16, 2008

(54) Systems and Methods for Determination of Endpoint of Chamber Cleaning Processes

(75) Inventors: Ing-Shin Chen, Danbury, CT (US); Jeffrey W. Neuner, Bethel, CT (US); Jeffrey F. Roeder, Brookfield, CT (US); Steven M. Bilodeau, Oxford, CT (US); Bryan C. Hendrix, Danbury, CT (US); Philip S.H. Chen, Bethel, CT (US)

Correspondence Address: INTELLECTUAL PROPERTY / TECHNOLOGY LAW, PO BOX 14329, RESEARCH TRIANGLE PARK, NC, 27709, US

(73) Assignee: ADVANCED TECHNOLOGY MATERIALS, INC., Danbury, CT (US)

(21) Appl. No.: 12/088,825

(22) PCT Filed: Oct. 3, 2006
(86) PCT No.: PCT/US2006/038358

§ 371 Date: Mar. 31, 2008

(30) Foreign Application Priority Data
Oct. 3, 2005 (US) 60723221
Apr. 5, 2006 (US) 60789439

(51) Int. Cl. B08B 13/00

(52) U.S. Cl. 134/18; 134/58 R

(57) ABSTRACT

Apparatus and method for determination of the endpoint of a cleaning process in which cleaning fluid is contacted with a structure to effect cleaning thereof. The cleaning process includes contacting a cleaning fluid with a structure to be cleaned and producing a cleaning effluent having a sensible heat thermal energy characteristic corresponding to extent of cleaning of the structure, disposing an object in the cleaning effluent that interacts with the cleaning effluent to produce a response indicative of the sensible heat thermal energy characteristic of the cleaning effluent, and monitoring such response to determine when the cleaning is completed. An endpointing algorithm and endpoint monitoring are also described, as well as endpoint monitor sensor elements that are useful to determine endpoint conditions in an efficient and reproduceable manner.

### CROSS-REFERENCE TO RELATED APPLICATIONS

This patent application claims priority to U.S. Provisional Patent Application No. 60/723,221 filed Oct. 3, 2005 in the name of Ing-Shin Chen, et al. for “SYSTEMS AND METHODS FOR DETERMINATION OF ENDPOINT OF CHAMBER CLEANING PROCESSES,” and U.S. Provisional Patent Application No. 60/789,439 filed Apr. 5, 2006 in the name of Ing-Shin Chen, et al. for “SYSTEMS AND METHODS FOR DETERMINATION OF ENDPOINT OF CHAMBER CLEANING PROCESSES,” both applications of which are hereby incorporated by reference as is set forth herein.

### FIELD OF THE INVENTION

The present invention relates to determination of the endpoint of a process in which fluid is contacted with a structure for processing thereof, e.g., cleaning processes for removal of deposits from semiconductor process tool chambers.

### DESCRIPTION OF THE RELATED ART

The semiconductor and flat-panel display industries employ gas-phase cleaning for removal of deposited materials from surfaces of the process tools, such as wall surfaces of chambers in which thin-film deposition processes are conducted.

In such gas-phase cleaning processes, it is highly desirable to determine the endpoint of the cleaning procedure—the point in time at which cleaning has taken place to a sufficient extent—in order to terminate the cleaning process at such point, thereby minimizing the amount of cleaning reagent required, the down-time of the process tool required for cleaning, the maintenance expenses associated with cleaning, and the environmental impact due to the need to treat the cleaning effluent to abate toxic or otherwise deleterious materials therein.

Among the many deposition techniques used in semiconductor manufacturing, chemical vapor deposition (CVD) of thin-film materials is extensively used.

CVD is routinely used to deposit selected metals (e.g., tungsten, barium, titanium, aluminum, copper, etc.) and interlayer dielectrics (e.g., SiO₂). The deposition is generally non-selective in nature and therefore takes place on the silicon wafer surface as well as the chamber interior. The deposits on the chamber interior, if not removed, will accumulate over time and eventually flake off onto the wafer surface in the form of particulates, which may render the wafer deficient or even useless for its intended purpose.

This particulates contamination problem is aggravated by the fact that the silicon wafer typically runs through a CVD chamber multiple times during the manufacturing lifecycle. Frequent chamber cleaning therefore is essential to maintain low wafer defectivity and adequate process reliability and repeatability. In some critical applications, it may even be necessary to perform chamber cleaning immediately after each deposition cycle. To mitigate impact on tool throughput, it is imperative to keep the duration of the clean cycle short and to maintain the chamber in a repeatable clean state for subsequent deposition.

In the conventional cleaning approaches, deposit removal from the process chamber interior is customarily performed by exposing the chamber interior to reactive gaseous species generated from plasma—e.g., fluorine radicals—that scavenge the deposit and form volatile byproducts. The volatile byproducts are pumped out of the chamber as process effluent.

Early implementations of chamber clean employ a plasma that is generated in situ. This implementation scheme is particularly appealing for plasma-enhanced chemical vapor deposition (PECVD) tools where in situ plasma generation is readily available.

There are nevertheless several inherent deficiencies associated with in situ plasma generation techniques. The conventional parallel plate radio frequency plasma used in these PECVD tools is not optimally configured for chamber cleaning. These clean processes employ perfluorocarbon (PFC) feed gases that exhibit low dissociation efficiency, resulting in high PFC emissions and associated high abatement costs. The poor utilization of the plasma source gas also results in excessively long clean times, which in many instances exceeds the deposition operation in duration. The chamber interior components in direct contact with the plasma suffer damage from energetic ion bombardment over time, while those shielded from the plasma are not always properly cleaned.

As a consequence of these deficiencies, an alternative scheme—remote plasma generation—has gained increasing industry acceptance. This alternative approach employs a dedicated plasma source that is specifically engineered to generate reactive species for chamber clean applications. The plasma source is positioned ex situ, in relation to the chamber to be cleaned, and the reactive cleaning species are channeled downstream to the chamber through a transport tube. The cleaning action as a result is purely chemical in nature, and energetic ion bombardment is practically absent. When nitrogen trifluoride (NF₃) is used in place of fluorocarbons as the feed gas, the dissociation is nearly complete, resulting in substantially higher utilization efficiency, shorter clean time, and minimal effluent release. With these significant benefits, remote plasma using NF₃ feed gas has been adopted in advanced semiconductor manufacturing processes to etch or clean a variety of thin film materials.

The progressively increasing deployment of remote plasma generation cleaning systems also introduces a corresponding need for development of alternative chamber clean endpointing solutions that are amenable to commercial implementation. Existing solutions for in situ plasma cleans—e.g., optical emission spectroscopy (OES) and impedance tuning—are generally designed to monitor changes in plasma characteristics. These solutions are not readily adaptable to remote plasma cleans. Existing solutions for remote plasma cleans often examine changes in the plasma effluent by chemical identification techniques, since the chemical composition of the plasma effluent changes over time, with etch byproducts (e.g., SiF₄) dominating the plasma effluent at the beginning of the clean cycle and gradually giving way to unreacted etchant species (e.g., F or F₂) as the chamber deposit is progressively removed. These chemical identification techniques have not proven to be practical in application to commercial semiconductor manufacturing operations.

Accordingly, the art continues to seek improvement in systems and techniques for determining the endpoint of remote plasma cleans.

### SUMMARY OF THE INVENTION

The present invention relates to determination of the endpoint of a process in which fluid is contacted with a structure for processing thereof, e.g., cleaning processes for removal of deposits from semiconductor process tool chambers.

In one aspect, the invention relates to an endpoint monitor adapted for determining an endpoint of a cleaning process in which a cleaning fluid is contacted with a structure to be cleaned and produces a cleaning effluent, for responsive termination of the cleaning process, such endpoint monitor comprising at least one of the following monitoring assemblies:

(a) an endpoint monitoring assembly comprising a constant temperature probe adapted to be disposed in the cleaning effluent, and a power source operatively coupled with the constant temperature probe and adapted to variably supply power to the constant temperature probe in an amount maintaining the constant temperature probe at a predetermined temperature level, such power source providing a monitoring signal indicative of variable power supplied to the constant temperature probe in the cleaning effluent, for transmission to a central processing unit arranged to receive such monitoring signal and produce an output to terminate the cleaning process in response to change in the monitoring signal indicating that the endpoint has been reached; and
(b) and endpoint monitoring assembly comprising a radiation-emissive target adapted to be disposed in the cleaning effluent and to be thermally activated by the cleaning effluent to emit radiation, a window arranged to transmit emitted radiation from the target therethrough, and a radiation monitor arranged to receive emitted radiation transmitted through the window, such the radiation monitor providing a monitoring signal indicative of a radiation emitted by the target, for transmission to a central processing unit arranged to receive such monitoring signal and produce an output to terminate the cleaning process in response to change in the monitoring signal indicating that the endpoint has been reached.

In another aspect, the invention relates to a cleaning process comprising contacting a cleaning fluid with a structure to be cleaned and producing a cleaning effluent having a sensible heat thermal energy characteristic corresponding to extent of cleaning of such structure, disposing an object in the cleaning effluent that interacts with the cleaning effluent to produce a response indicative of the sensible heat thermal energy characteristic of the cleaning effluent, and monitoring such response to determine when such cleaning is completed.

In a further aspect, the invention relates to a calorimetric probe having a solid-state construction and adapted for immersion in a fluid during an endpointing operation and operation at constant temperature level by drawing power from a power supply in a time-varying amount to maintain the constant temperature level, in response to time-varying heat flux carried by the fluid in which the probe is immersed.

A further aspect of the invention relates to a semiconductor manufacturing facility including an endpoint monitor as above described.

A still further aspect of the invention relates to method of conducting a cleaning process utilizing a cleaning fluid and producing a cleaning effluent whose thermal character corresponds to an extent of completion of the cleaning process, such method comprising monitoring variation of a cleaning process variable that is a function of the thermal character of the cleaning effluent, and terminating the cleaning process in response to change of the cleaning process variable indicative of completion thereof.

Yet another aspect of the invention relates to a method of determining endpoint of a plasma generation cleaning process producing cleaning species for contacting with a structure to be cleaned, to yield a cleaning effluent, such method comprising calorimetrically monitoring interaction of a monitoring body contacting the cleaning effluent to determine endpoint by a change of such interaction.

The invention in a still further aspect relates to a method of determining endpoint of a cleaning process in which a cleaning medium is contacted with a surface or structure to be claimed, and produces an effluent, such method comprising monitoring an energetic characteristic of the effluent indicative of progress of cleaning to determine such endpoint of the cleaning process.

In a further aspect, the invention relates to a method of processing a substrate, wherein the substrate exhibits a response that is indicative of progress of such processing, such method including monitoring the response and responsively terminating the processing when the response is indicative of completion of the processing.

A still further aspect of the invention relates to a monitoring assembly including a pyrometer, a window through which radiation is transmissible to the pyrometer, and an anti-fogging unit adapted to maintain the window free of condensed deposits thereon, wherein said anti-fogging unit comprises at least one of the following elements:

(a) a resistive element adapted to resistively heat the window;
(b) a source of heated gas arranged to impinge heated gas on the window; and
(c) an enclosure around the window incorporating a heater adapted to warm the window, with an aperture in the enclosure permitting transmission of said radiation through the window.

The invention in another aspect relates to an endpoint monitor sensor element including an amorphous carbon filament within a silicon carbide cylindrical body, wherein the silicon carbide cylindrical body is encased in a nickel sheath, said nickel sheath including end portions adapted to contact an electrical power supply circuit, and a main longitudinal sheath portion isolated from electrical conduction with the end portions by an isolation structure.

A further aspect of the invention relates to an endpoint monitor sensor element including an amorphous carbon filament within a silicon carbide cylindrical body, wherein the silicon carbide cylindrical body is coupled at end portions thereof with nickel contacts, and the silicon carbide cylindrical body along a main longitudinal length intermediate said end portions is encased in an insulative sheath.

Yet another aspect of the invention relates to a process installation including a chamber requiring cleaning and an endpoint monitor including such endpoint monitor sensor element.

In another aspect, the invention relates to a method of conducting a clean process including flow of a cleaning medium through a process chamber to remove deposits from the chamber and discharge a cleaning medium effluent from the chamber, such method comprising: monitoring power as a function of time during the clean process; and determining an endpoint of the clean process as occurring when the monitored power as a function of time transitions in trace form to a plateau character

An additional aspect of the invention relates to a method of conducting a clean process including flow of a cleaning medium through a process chamber to remove deposits from the chamber and discharge a cleaning medium effluent from the chamber, said method comprising: monitoring power as a function of time during the clean process and generating a corresponding signal including a true signal and a noise component; and determining an endpoint of the clean process as occurring when magnitude of the noise component is at least equal to temporal change of the true signal.

A further aspect of the invention relates to a process installation including a chamber requiring cleaning and an endpoint monitor adapted to monitor said cleaning by one of the above-described methods.

Other aspects, features and embodiments of the invention will be more fully apparent from the ensuing disclosure and appended claims.

### BRIEF DESCRIPTION OF THE DRAWINGS

FIG. 1 is a schematic representation of a semiconductor manufacturing facility employing a system for determining endpoint of a cleaning operation in a semiconductor process tool, according to one embodiment of the invention.

FIG. 2 is a schematic representation of a plasma test manifold.

FIG. 3 is a graph of power, in milliwatts, and a corresponding graph of blade positions, as a function of time, in minutes, showing the temporal evolution of impedance tuning blade positions and calorimetric probe power during several experimental nitride deposition-clean cycles on an Applied Materials P5000 CVD tool.

FIG. 4 is a graph of power, in milliwatts, and power readings at the end of each clean cycle (“@EOC”), as a function of time, in minutes, showing the temporal evolution of calorimetric probe power across a 25 wafer cassette run of TEOS-oxide deposition-clean cycles, conducted on an Applied Materials P5000 CVD tool, together with power readings at the end of each clean cycle.

FIG. 5 is a graph of probe power, in milliwatts, and non-dispersive infrared (NDIR) signal (in arbitrary units), and a graph of pressure, in millitorr, all as a function of time, in minutes, showing the temporal evolution of the NDIR signal, calorimetric probe power, and chamber pressure, during an oxide deposition-clean cycle on an AKT 15K CVD tool.

FIG. 6 is a schematic representation of a modified plasma test manifold similar to that shown in FIG. 2.

FIG. 7 is an enlarged view of a portion of the FIG. 6 test manifold, showing the placement of the nickel target.

FIG. 8 is a graph of the residual gas analyzer pressure, in torr×10⁻⁹, for fluorine and nitrogen trifluoride, and a graph of the thermocouple readings, for T-type (internal) and K-type (infrared external), as a function of time, during three plasma cleaning cycles (the shaded areas indicate periods during which the plasma generator was activated for cleaning).

FIG. 9 is a schematic representation of the plasma test manifold of FIG. 2 as labeled to show temperature monitoring sites thereof.

FIG. 10 is a graph of the outputs of three temperature monitoring devices, a pyrometer, in millivolts, a Lorex KF25 thermocouple, in ohms, and a bare T-type thermocouple, in millivolts, as a function of time, during consecutive nitrogen trifluoride pulses.

FIG. 11 is a graph showing the superimposed traces of the graph of FIG. 10 during the first NF₃ pulse thereof.

FIG. 12 is a schematic perspective view of an endpoint monitor sensor element according to one embodiment of this invention, in which the nickel coating of the Ni-coated filament is electrically isolated.

FIG. 13 is a schematic perspective view of an endpoint monitor sensor element according to another embodiment of this invention, in which the nickel coating of the Ni-coated filament is electrically isolated.

FIG. 14 is a graph of resistance, in ohms, as a function of time, in minutes, showing the response of a Teflon-coated nickel plated SiC filament (curve A), a discontinuous nickel plated silicon carbide filament (curve D), a nickel plated SiC filament plated at a current of 0.125 milliamps for 5 hours (curve B) and a nickel plated SiC filament plated at 0.25 milliamps for 5 hours (curve E), with curve C representing the plasma on/off cycle.

FIG. 15 is a corresponding graph of the signal response as dR/R as a function of time, in minutes, showing that the Teflon® coated element and discontinuous element had the lowest dR/R values.

FIG. 16 is a corresponding graph of the absolute delta R (dR) as a signal, in ohms, as a function of time, in minutes.

FIG. 17 is a sample response trace for a process chamber clean, showing three regions identified with the trace, viz., Region I, a starting transient, Region II, a cleaning signature, and Region III, a post-ending signature.

FIG. 18 is a graph of SiN process traces, corresponding to two SiN deposit thicknesses.

### DETAILED DESCRIPTION OF THE INVENTION, AND PREFERRED EMBODIMENTS THEREOF

The present invention relates to determination of the endpoint of a cleaning process in which cleaning fluid is contacted with a structure to effect cleaning thereof.

Although a described herein primarily in reference to semiconductor manufacturing applications, it will be recognized that the systems and methods of the present invention are likewise amenable to use in the manufacture of flat-panel displays. Accordingly, reference herein to semiconductors and semiconductor manufacturing is correspondingly intended to encompass flat-panel displays and their manufacture.

The invention in one aspect is based on the principle that the cleaning effluent has a sensible heat thermal energy characteristic, and that a correlation can be established between such thermal energy characteristic and the cleaning of the structure with which the cleaning medium has been contacted to produce such effluent. More specifically, the invention in such aspect reflects the approach of measuring the energy exchange between the effluent and an in-stream object (i.e., an object that is disposed in the effluent stream) to infer the condition of the structure being cleaned, e.g., a process chamber for chemical vapor deposition.

The invention contemplates an endpoint monitor adapted for determining an endpoint of a cleaning process in which a cleaning fluid is contacted with a structure to be cleaned and produces a cleaning effluent, for responsive termination of the cleaning process, such endpoint monitor comprising at least one of the following monitoring assemblies:

(a) an endpoint monitoring assembly comprising a constant temperature probe adapted to be disposed in the cleaning effluent, and a power source operatively coupled with the constant temperature probe and adapted to variably supply power to the constant temperature probe in an amount maintaining the constant temperature probe at a predetermined temperature level, such power source providing a monitoring signal indicative of variable power supplied to the constant temperature probe in the cleaning effluent, for transmission to a central processing unit arranged to receive such monitoring signal and produce an output to terminate the cleaning process in response to change in the monitoring signal indicating that the endpoint has been reached; and
(b) an endpoint monitoring assembly comprising a radiation-emissive target adapted to be disposed in the cleaning effluent and to be thermally activated by the cleaning effluent to emit radiation, a window arranged to transmit emitted radiation from the target therethrough, and a radiation monitor arranged to receive emitted radiation transmitted through the window, such the radiation monitor providing a monitoring signal indicative of a radiation emitted by the target, for transmission to a central processing unit arranged to receive such monitoring signal and produce an output to terminate the cleaning process in response to change in the monitoring signal indicating that the endpoint has been reached.

One embodiment of the invention contemplates an endpoint monitor including endpoint monitoring assembly (a) and thus can be operatively coupled to a central processing unit arranged to receive such monitoring signal and produce an output to terminate the cleaning process in response to change in the monitoring signal indicating that the endpoint has been reached. For such purpose, the central processing unit may be operatively adapted to transmit such output to a flow control valve through which the cleaning fluid is flowed to the cleaning process, for closure of the flow control valve. The output can be transmitted to the flow control valve via a valve actuator.

Such endpoint monitor can be deployed in a semiconductor manufacturing facility, e.g., a facility in which the cleaning fluid comprises plasma-generated cleaning species, such as cleaning species generated from nitrogen trifluoride that comprise fluoro species. The structure to be cleaned can include a semiconductor manufacturing process tools such as a chemical vapor deposition chamber.

The endpoint monitor of the invention can alternatively, or additionally, include endpoint monitoring assembly (b). Such endpoint monitor can be operatively coupled to a central processing unit arranged to receive the monitoring signal and produce an output to terminate the cleaning process in response to change in the monitoring signal indicating that the endpoint has been reached. The central processing unit can be operatively adapted to transmit the output to a flow control valve through which the cleaning fluid is flowed to the cleaning process, for closure of the flow control valve, e.g., by transmission of the output to the flow control valve via a valve actuator.

Such endpoint monitor can be deployed in a semiconductor manufacturing facility, e.g., a facility in which the cleaning fluid comprises plasma-generated cleaning species generated from nitrogen fluoride, and contain fluoro species. The structure to be cleaned in such manufacturing facility may be a semiconductor manufacturing process tool such as a chemical vapor deposition chamber.

The radiation monitor can be of any suitable type, and can comprise a pyrometer, e.g., an infrared pyrometer having a temperature operating range of from 25° C. to 200° C. (it is to be noted that this temperature range refers to the surface temperature of the object producing radiation, and that the infrared pyrometer is responsive to the infrared radiation produced by objects having surface temperature in such range). The window associated with the pyrometer can be formed using other appropriate materials, such as material selected from among sapphire and Group II metal fluorides (e.g., barium fluoride, calcium fluoride and magnesium fluoride).

The target can be formed of any suitable material, such as a material selected from the group consisting of metals, polymeric materials, and alloys, combinations and composites thereof. In one embodiment, the target is formed of a material selected from the group consisting of nickel, copper, aluminum and polytetrafluoroethylene.

The structure to be cleaned in the broad practice of the invention can be of any suitable type, and in one embodiment comprises an enclosure such as a semiconductor manufacturing process chamber, e.g., a chemical vapor deposition chamber.

The endpoint monitor of the invention may be deployed in a semiconductor manufacturing facility, in a chemical vapor deposition chamber that is coupled with a source of process gas for chemical vapor deposition processing of a semiconductor article, and the chemical vapor deposition chamber is coupled with a source of the cleaning fluid for the cleaning process. In such implementation, the aforementioned central processing unit can be adapted to carry out a cycle in which the chemical vapor deposition processing and the cleaning process are carried out in alternating sequence.

In another aspect, the invention relates to a cleaning process comprising contacting a cleaning fluid with a structure to be cleaned and producing a cleaning effluent having a sensible heat thermal energy characteristic corresponding to extent of cleaning of the structure, disposing an object in the cleaning effluent that interacts with the cleaning effluent to produce a response indicative of the sensible heat thermal energy characteristic of the cleaning effluent, and monitoring the response to determine when the cleaning is completed.

The response in such process may comprise emissivity of the object, and/or the object may be constituted as a constant temperature probe that is adapted to draw power from a power supply in an amount necessary to maintain a predetermined temperature level, wherein the response comprises change in power draw from the power supply.

In the practice of such cleaning process, the contacting of the cleaning fluid with the structure to be cleaned can be terminated upon determining that the cleaning is completed to the desired extent, e.g., by terminating the flow of cleaning fluid from the source thereof to the structure to be cleaned.

The cleaning fluid can include plasma-generated cleaning species, such as those generated from nitrogen fluoride, whereby the cleaning fluid contains fluoro species. Although described herein in primary reference to effluents of cleaning operations conducted using plasma-generated cleaning species, it will be appreciated that the invention is not thus limited, and encompasses and extends to cleaning processes generally, whether or not, the cleaning medium is generated by use of a plasma.

Further, while the discussion herein is directed primarily to the use of nitrogen trifluoride as a cleaning medium or source material for plasma generation to produce cleaning species, you will be appreciated that the invention is not thus limited, but rather extends to and encompasses the use of other cleaning media, such as the use of other perfluorocarbon cleaning agents.

Additionally, while the ensuing discussion is directed primarily to cleaning of structures such as process chambers in which accumulations have formed of material from prior processing, in which the prior processing is a vapor deposition unit operation, it will be appreciated that the invention is not thus limited in applicability, and that the cleaning may be directed to removal of any type deposits or contaminants on a surface or article, deriving from any source or prior processing. For example, in respect of microelectronic device manufacture, the cleaning method and apparatus of the invention can be utilized for cleaning operations subsequent to carrying out physical vapor deposition (PVD), sputtering, electrolytic deposition, chemical vapor deposition, ion implantation, plasma-assisted deposition, etc.

The cleaning process can include use of a central processing unit to carry out a cycle in which chemical vapor deposition processing and the cleaning process are carried out in alternating sequence.

In a specific embodiment, the invention contemplates a calorimetric probe having a solid-state construction and adapted for immersion in a fluid during an endpointing operation and operation at constant temperature level by drawing power from a power supply in a time-varying amount to maintain the constant temperature level, in response to time-varying heat flux carried by the fluid in which the probe is immersed. Such calorimetric probe advantageously is fabricated of a material that is at type and resistant in exposure to fluorine.

A semiconductor manufacturing facility employing the cleaning process of the present invention may further include process equipment that is supplied with process fluid from a supply thereof. The supply of process fluid may be provided as including fluid storage and dispensing vessels of a type containing a physical adsorbent material on which the process fluid is adsorbed, for dispensing under desorption conditions, or alternatively of a type including an internally disposed gas pressure regulator therein.

The semiconductor manufacturing facility can be arranged in effluent flow communication relationship to an affluent abatement unit for treatment of the cleaning effluent and/or the active processing effluent.

In another aspect, the invention contemplates a method of conducting a cleaning process utilizing a cleaning fluid and producing a cleaning effluent whose thermal character corresponds to an extent of completion of the cleaning process, such method comprising monitoring variation of a cleaning process variable that is a function of the thermal character of the cleaning effluent, and terminating the cleaning process in response to change of the cleaning process variable indicative of completion thereof.

The cleaning process may for example be conducted to clean a chamber in which deposits have accumulated during prior use thereof. The cleaning process may include in situ plasma generation of cleaning species or alternatively remote plasma generation of cleaning species.

Alternatively, the cleaning medium can be of any suitable type or phase or multiphase character. In one embodiment, the cleaning medium includes a cleaning fluid that is at least partially generated from a solid, liquid or gaseous source material.

In another aspect, the invention relates to a method of determining endpoint of a plasma generation cleaning process producing cleaning species for contacting with a structure to be cleaned, to yield a cleaning effluent, such method comprising calorimetrically monitoring interaction of a monitoring body contacting the cleaning effluent to determine endpoint by a change of the interaction.

A still further aspect of the invention relates to a method of manufacturing a microelectronic device using the methods or systems described herein and, optionally, incorporating such microelectronic devices into a product. One embodiment relates to a method of manufacturing a microelectronic device comprising cleaning a semiconductor tool using the methods described herein and using the semiconductor tool to manufacture the microelectronic device. The term “microelectronic device” corresponds to semiconductor substrates, flat panel displays, and microelectromechanical systems (MEMS), manufactured for use in microelectronic, integrated circuit, or computer chip applications. It is to be understood that the term “microelectronic device” is not meant to be limiting in any way and includes any substrate that will eventually become a microelectronic device or microelectronic assembly.

Yet another aspect of the invention relates to improved microelectronic devices, and products incorporating same, made using the methods of the invention described herein and to products incorporating such improved microelectronic devices.

In instances in which an in-stream object is employed for generation of a signal indicative of the progress, stage, endpoint or approach to endpoint of the cleaning operation, it will be appreciated that such signal may be relayed directly to a signal processing unit, such as a process monitoring unit, by wired or wireless transmission, or in other manner, and that such signal may be relayed to an intermediate storage size transmission element, such as a radio frequency identification (RFID) device.

The invention thus contemplates a method of determining endpoint of a cleaning process in which a cleaning medium is contacted with a surface or structure to be claimed, and produces an effluent, in which the method involves monitoring an energetic characteristic of the effluent indicative of progress of cleaning, to determine the endpoint of the cleaning process.

The energetic characteristic may be heating of an in-stream object by the effluent, thermal state of the effluent, or a characteristic mediated by the effluent, such as emissivity, diffusional character (such as where the diffusivity of a material of an in-stream object is modulated or in some way altered by the character or composition of the effluent), etc.

The invention also contemplates applications in which pyrometric or other monitoring is utilized in wafer etching or other processes involving a substrate, wherein the substrate is the in-stream object that is monitored by the pyrometric or other monitoring unit, and the monitoring unit is employed to determine the endpoint of active processing, in a manner analogous to that otherwise employed in determining the endpoint of cleaning operations. Accordingly, any application in which progress of a treatment or processing operation can be monitored and a monitoring signal is employed for termination of the treatment or processing operation can be practiced within the broad scope of the present invention.

In the use of optical viewing windows, such as those utilized in connection with pyrometric monitoring described hereinabove, deposits may form on the optical view window due to condensation of deposition materials over time, a condition often referred to as “window fogging.”

In order to avoid any drift in the IR measurement, a deposit-free window is desirable. Internal gas purges can be utilized to reduce window fogging, by suppressing contact of the gas phase reactants with the window. However, fogging may still occur in practice due to imperfect purging. An alternative includes heating the window to a temperature that prevents condensation, but is low enough to prevent decomposition. This can be carried out by electrical resistance heating elements affixed to the window in a manner that will allow IR penetration (e.g., by use of thin strips/wires/stripes), or by heating the window at the exterior thereof with a hot gas that is not IR-absorbing. Ideally, the wavelength of the pyrometer is tuned to a spectral frequency other than that of the resistive elements. A further approach to prevent window fogging involves the provision of an enclosure around the window with a heating unit (e.g., a band heater) to warm the window, with an aperture to allow the pyrometer beam to pass through the optical path to the target.

The invention will now be more fully described with reference to specific features, aspects and embodiments.

The invention in one embodiment utilizes ex situ infrared pyrometry to measure surface temperature of an in-stream object through an optical window, as hereinafter more fully described.

To minimize the sensitivity constraints of the infrared pyrometer, the placement and form factor of the in-stream object are selected to provide appropriate accuracy and reliability. The in-stream object is desirably of small thermal mass, and thermally isolated from large thermal mass structures such as the effluent gas conduit or other components of the flow circuitry in which the object is deployed. In one embodiment of the invention, the in-stream object is or includes a piece of metal mesh that is thermally isolated from the wall surfaces of the effluent exhaust conduit.

The pyrometer used in such endpoint monitoring system in one embodiment of the invention is an infrared pyrometer having a temperature operating range of from room temperature (e.g., 25° C.) to a temperature of 200° C. The peaks in the radiation curve span from 6 to 10 μm in this temperature range, and the pyrometer is adapted to provide a high spectral response over at least a portion of this spectral range.

The pyrometer in such endpoint monitoring system is advantageously disposed in sensing relationship to the in-stream object through an intervening window, e.g., a window in the effluent discharge conduit, mounted in an opening in the wall of such conduit. The window desirably is of an etch-resistant character, to resist etching and degradation by cleaning species in the effluent stream that come into contact with the window, and is characterized by high transmissivity of infrared radiation in the selected spectral operating range.

In one embodiment, the window material is sapphire, which resists etching by halogen etchants and has a radiation transmissivity extending into the far infrared.

In general, the infrared-transmissive window can be formed of any suitable IR-transmissive material, including, for example, Group II metal fluorides, such as barium fluoride, calcium fluoride or magnesium fluoride.

As an alternative to the use of a window as an intermediary transmissive element between the radiation monitor and the cleaning fluid, radiation-transmissive optical fibers may be employed to transmit radiation from the emissive object in the effluent to the radiation monitor. Such optical fibers may be formed of any suitable material of construction, such as for example, silver halides whose halide constituent may be fluorine, chlorine, bromine or iodine.

The in-stream object, whose thermal emissivity is sensed by the infrared pyrometer, is formed of suitable material that is resistant to attack by etchant species present in the effluent stream and provides high emissivity surface(s). In various embodiments of the invention, the in-stream object is formed of metal, (e.g. nickel, copper, aluminum), high-temperature polymeric materials (e.g., polytetrafluoroethylene), or alloys, combinations or composites of constituting materials having appropriate emissivity and etch resistance, in exposure to the effluent from the cleaning operation.

In one embodiment, which is adaptable to in situ plasma cleans as well as remote plasma generation systems, the monitoring system of the invention utilizes a calorimetric probe having an all solid-state construction that is adapted to be immersed in the plasma effluent during the endpointing operation. When operated at constant temperature, the probe power is closely related to heat flux carried by the effluent, and correlates with conditioning of the upstream chamber that is being cleaned. By virtue of its downstream location, the probe operation does not depend on the plasma sourcing scheme (of in situ operation or alternatively remote generation of plasma).

Such endpoint monitoring system has been successfully demonstrated in both in situ and remote plasma generation chamber cleaning of semiconductor manufacturing production tools.

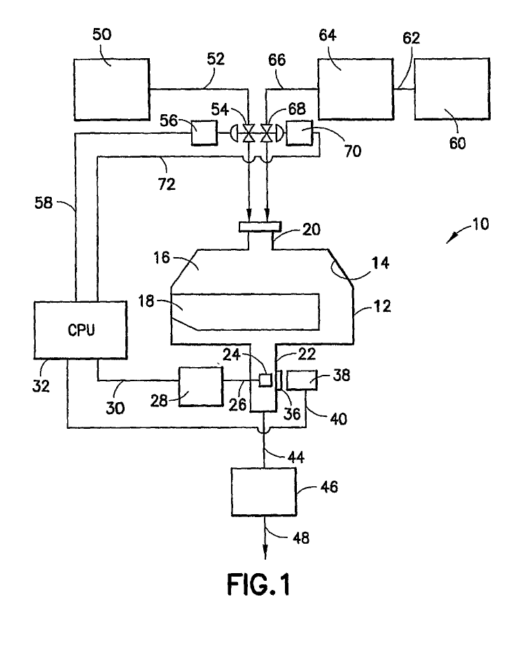

FIG. 1 is a schematic representation of a semiconductor manufacturing facility 10 employing a system for determining endpoint of a cleaning operation in a semiconductor process tool, according to one embodiment of the invention.

The semiconductor manufacturing facility of FIG. 1 includes a chemical vapor deposition chamber 12 defining an interior volume 16 bounded by interior wall surfaces 14 of the chamber. The chamber includes an inlet 20 for flow of fluid into the chamber interior volume 16, and an outlet passage 22 for discharge of fluid from the interior volume 16 of the deposition chamber.

Disposed in the interior volume 16 of the chamber 12 is a wafer chuck 18 for mounting of a wafer thereon to accommodate contacting with a precursor vapor for deposition of metal or formation of other material layers on the wafer surface under vapor deposition conditions.

Coupled to the inlet 20 of the vapor deposition chamber 12 is a pair of fluid feed lines. A first feed line 52 having flow control valve 54 therein is coupled with a source 50 of precursor for the vapor deposition process, such as for example an organometallic source reagent for tungsten, titanium, or other metal deposition species.

The source 50 can include a storage and dispensing vessel of any suitable type, such as a type containing a physical adsorbent material on which is adsorbed a fluid to be dispensed under dispensing conditions effecting desorption of the adsorbed fluid from the physical adsorbent material, or alternatively, a vessel equipped with an internally disposed gas pressure regulator, as commercially available from ATMI, Inc. (Danbury, Conn.) under the SDS, SAGE and VAC trademarks. Fluid supply vessels of various types potentially useful in the broad practice of the present invention are more fully described in U.S. Pat. No. 5,518,528; U.S. Pat. No. 5,704,965; U.S. Pat. No. 5,704,967; U.S. Pat. No. 5,935,305; U.S. Pat. No. 6,406,519; U.S. Pat. No. 6,204,180; U.S. Pat. No. 5,837,027; U.S. Pat. No. 6,743,278; U.S. Pat. No. 6,089,027; U.S. Pat. No. 6,101,816; U.S. Pat. No. 6,343,476; U.S. Pat. No. 6,660,063; U.S. Pat. No. 6,592,653; U.S. Pat. No. 6,132,492; U.S. Pat. No. 5,851,270; U.S. Pat. No. 5,916,245; U.S. Pat. No. 5,761,910; U.S. Pat. No. 6,083,298; U.S. Pat. No. 6,592,653; and U.S. Pat. No. 5,707,424, hereby incorporated herein by reference, in their respective entireties. Preferred vessels include SDS® and VAC® delivery vessels (ATMI, Inc., Danbury, Conn., USA).

Although the aforementioned physical absorbent material in various applications can be a solid-phase physical adsorbent material, vessels containing other types of sorbent media can be employed to store a fluid for subsequent disengagement of the fluid from the sorbent medium. In such respect, the sorbent medium may include a solvent, liquid, semi-solid or other material having capability as a storage medium.

For example, the fluid storage medium may be a reversible reactive liquid medium, e.g., an ionic liquid medium, capable of reactive uptake of fluid in a first step, and reactive release of previously taken up fluid in a second step, wherein the first and second steps are reverse reactions in relation to one another, and define a reversible reaction scheme. According to another embodiment, the vessel uses a liquid absorbent, such as those disclosed in U.S. Patent Publication No. 20040206241, hereby incorporated by reference in its entirety.

According to yet another embodiment, the vessel is a solids delivery vessel (e.g., of a type as commercially available from ATMI, Inc., Danbury, Conn., USA under the trademark ProEVap™), such as those disclosed in U.S. Pat. No. 6,921,062, U.S. Provisional Patent Application Ser. No. 60/662,515, or U.S. Patent Publication No. 20050039794, all of which are hereby incorporated by reference in their respective entireties.

The source 50 can also include one or more carrier gas supplies to provide a precursor stream containing carrier gas and active precursor species. Additionally, the source 50 may include heater or vaporizer equipment, appropriate flow circuitry, flow control valves, mass flow controllers, restricted flow orifice elements, manifolding, process monitoring devices, etc.

A second feed line 66 is coupled to the inlet 20 of the chemical vapor deposition chamber 12, and contains flow control valve 68 therein. The second fluid feed line 66 is joined to a plasma generator unit 64. The plasma generator unit 64 in turn is coupled by feed line 62 to cleaning gas source 60.

The flow control valve 54 in feed line 52 is operatively coupled with a valve actuator unit 56, and the valve actuator unit 56 is joined by signal transmission line 58 to CPU 32. The CPU 32 may be of any suitable type, and may comprise a general purpose programmable computer, microprocessor, programmable logic unit, or other computational module that is adapted and arranged for monitoring and control of the semiconductor manufacturing facility 10.

In like manner, the flow control valve 68 in feed line 66 is operatively coupled to a valve actuator unit 70. They valve actuator unit 70 in turn is joined by signal transmission line 72 to CPU 32.

Disposed in the outlet passage 22 is a calorimetric probe element 24, as an in-stream body that is joined by the electrical signal transmission line 26 to the power control module 28, which is adapted to maintain constant temperature of the calorimetric probe element 24 during cleaning conditions. The power control module 28 is joined by a signal transmission line 32 to CPU 32.

In the embodiment shown in FIG. 1, the outlet passage 22 has an opening in the wall surface thereof in which is disposed and infrared-transmissive window 36. The infrared-transmissive window 36 is arranged in infrared radiation transmissive relationship to pyrometer 38. The pyrometer 38 is coupled to CPU 32 by signal transmission line 40.

An effluent discharge line 44 is joined to the outlet passage 22 of the vapor deposition chamber 12 at one end of such line, with the other end being coupled with effluent treatment unit 46. The effluent treatment unit 46 can be of any suitable type, including for example effluent treatment scrubbers, oxidation or combustion equipment, chemical reaction vessels, and/or any other effluent abatement apparatus appropriate to the treatment of the effluent to yield a final purified effluent that is discharged from the effluent treatment unit 46 in vent line 48.

In operation, the semiconductor manufacturing facility 10 is arranged to carry out chemical vapor deposition in chamber 12. During the deposition operation, valve 68 in line 66 is closed, and valve 54 in line 52 is open to enable flow of the precursor fluid from a source 50 in line 52 to the chemical vapor deposition chamber 12. During such deposition, a wafer (not shown) is disposed on chuck 18 for contacting with the precursor of vapor under chemical vapor deposition conditions, for deposition of the desired species from the precursor vapor on the wafer surface. For such purpose, the wafer on the chuck 18 may be heated, e.g., electrical resistance heating, infrared radiant heating, etc., as necessary or desirable in the specific application.

After contacting the wafer for chemical vapor deposition, the effluent vapor depleted in the deposition species is discharged from the chamber 12 in discharge of passage 22 and flows in line 44 to the effluent treatment unit 46, in which toxic or otherwise deleterious or desirably recovered species are removed from the effluent, to produce a purified effluent that is discharged from the effluent treatment unit 46 in vent line 48.

Such chemical vapor deposition operation is continued for a predetermined time appropriate to the semiconductor device structure being fabricated. The CPU 32 may be adapted and arranged for monitoring of the chemical vapor deposition operation, by deployment of appropriate sensors, instruments, and the like, and the CPU may be operatively adapted in the system to modulate the flow rate of the precursor stream in line 52 that is passed to the chemical vapor deposition chamber, by means of the valve actuator 56. Thus, the valve actuator 56 may be selectively opened or closed to an extent providing a desired flow rate of the active precursor species into the interior volume 16 of the chemical vapor deposition chamber 12. Additionally, the CPU 32 may be operatively arranged to control the precursor or source 50, in respect of the mixing of the precursor with carrier gas, to provide a predetermined concentration of precursor species in the feed gas mixture passed to the chemical vapor deposition chamber.

As a further variation, the CPU 32 may be adapted for monitoring and/or control of the various other tools, materials and operations in the semiconductor manufacturing facility 10.

After the chemical vapor deposition operation has been completed, the flow of precursor to the chemical vapor deposition chamber 12 is terminated by closure of valve 54 in line 52, by appropriate action of the valve actuator 56 under the control of the CPU 32.

Concurrently, valve 68 in line 66 is opened, and cleaning gas from source 60 is flowed in line 62 to plasma generator 64, to generate a plasma including cleaning species. For example, the source 60 may supply nitrogen trifluoride to the plasma generator 64, whereby active fluorine radicals and fluoro species are generated, which are effective for cleaning of deposits from the interior wall surfaces 14 of the chemical vapor deposition chamber 12. Depending on the character of the deposits on the interior wall surfaces 14, a single cleaning gas may be employed, or alternatively, a mixture of different cleaning gases may be passed to the plasma generator 64, to generate active cleaning species effective for removal from interior wall surfaces 14 of the deposits at cumulative thereon during the prior chemical vapor deposition operation.

From the plasma generator, the active cleaning species are flowed in line 66 to the inlet 20 of the chemical vapor deposition chamber 12, for passage into the interior volume 16 of such chamber, to clean deposits from the wall surfaces 14 therein.

Effluent from the cleaning process flows into the discharge passage 22, from which it flows in line 44 to the effluent treatment unit 46 for purification and discharge of purified effluent in vent line 48. It will be appreciated that the treatment of the cleaning effluent may be carried out in an effluent treatment unit other than the effluent treatment unit employed for abatement of deleterious species from the chemical vapor deposition effluent, and for such purpose, line 44 may be joined in closed gas flow communication with a manifold, by means of which the respective CVD effluent and cleaning effluent may be passed to different effluent abatement units.

The remote plasma generation cleaning effluent flowing in discharge passage 22 contacts the calorimetric probe 24. The probe 24 is powered by a power source 28 coupled with the probe by electrical transmission line 26, to maintain a constant temperature. Thus, as the cleaning effluent contacts the probe 24, it will have a thermal character that is determined by the progress of the cleaning operation, the chemical reaction of the cleaning species with the deposits on the interior wall surfaces 14 of the CVD chamber 12, the temperature of chamber 12, etc. As a result of the dynamically changing thermal character of the cleaning effluent, the power required to maintain constant temperature of the probe element 24 will correspondingly vary. This variation in power draw by the probe element 24 is monitored by a power draw signal from the power source 28 communicated in signal transmission line 32 the CPU 32.

The power signal received by the CPU is monitored to determine a change indicative of the endpoint or desired completion state of the cleaning. At such endpoint, as sensed by the CPU, the CPU responsively transmits a signal in transmission line 72 to valve actuator 70 to close the flow control valve 68 in line 66, thereby terminating the cleaning operation.

In addition to the calorimetric monitoring capability afforded by the probe 24, the semiconductor manufacturing facility 10 may include other monitoring systems and capability for determining endpoint of the chamber cleaning operation, e.g., as back-up, or supplemental capability to the endpoint determination afforded by the calorimetric probe. In the latter case, the supplemental capability for endpoint monitoring may be employed to provide an additive or averaged signal for processing by the CPU or other signal processing unit, to enhance the accuracy and reliability of the overall endpoint detection system.

As a further variant, additional endpoint monitoring capability may be employed to monitor specific species in a cleaning effluent containing multiple active components, as part of an integrated monitoring and control system in which the probe 24 provides primary control of the termination of the cleaning operation, but other species are monitored by auxiliary means, such as in instances where there is sequential introduction of different cleaning agents, each directed to removal of a specific deposited species from the chamber interior wall surfaces.

In the FIG. 1 facility, such auxiliary endpoint monitoring is provided by the pyrometer 38, which monitors the infrared radiation emitted by the probe 24 and transmitted through window 36. The pyrometer 38 responsively generates a control signal that is transmitted in signal transmission line 42 to the CPU 32.

In a further aspect, the facility of FIG. 1 can be operated with only pyrometric monitoring of the cleaning operation, by the pyrometer 38. In such aspect, the monitoring signal transmitted by the pyrometer 38 in signal transmission line 40 undergoes a transition indicative of the endpoint of the cleaning process and such transition is detected by the CPU 32. The CPU then responsively terminates the fellow of the cleaning fluid to the plasma generator and/or the operation of the plasma generator, with closure of the valve 68 in the cleaning fluid feed line 66.

Considering the calorimetric probe and its operation in further detail, the constant temperature at calorimetric probe is immersed in the plasma effluent during the chamber cleaning process, and undergoes time-dependent heat exchange with the plasma effluent that is indicative of the progress of cleaning in such chamber. The heat exchange between the constant temperature of calorimetric probe and the flowing fluid predominantly involves convective heat transfer, with potential additional contributions from exothermic reactions (e.g., exothermic reactions effecting recombination of radicals) on the surface of the probe. The probe as a result of its heat transfer behavior and consequent variation in power draw requirement for maintenance of constant temperature is adapted to detect differences in heat convection between effluent containing cleaning byproducts and the effluent containing cleaning fluid per se. As a result, the transition from a byproducts-rich effluent stream to a byproducts-poor effluent stream is sensed, and utilized to terminate the cleaning operation.

The cleaning effluent temperature typically is higher during deposit removal as a result of enthalpy contributed by exothermic etching reactions that take place during the cleaning operation. The calorimetric probe detects these collective changes (exothermic reactions on the probe surface, convective heat contrast associated with changes in thermal conductivity and kinematic viscosity, and effluent temperature change) associated with the effluent composition transition during chamber cleaning, to enable the endpoint of the cleaning operation to be detected in a reliable and reproducible manner.

The features and advantages of the invention are more fully shown by the following examples, which are intended to be illustrative in character, and not to be limitingly construed, as regards the character and scope of the present invention.

### Example I

A calorimetric probe was constructed with an electrically insulating fiber coated with a nickel cladding of nominal 3 μm thickness. Nickel was selected for its resistance to fluorine etching, to accommodate exposure to a fluorine plasma environment. To achieve constant temperature operation, the probe power was modulated through a feedback control scheme to maintain probe resistance at a predetermined setpoint.

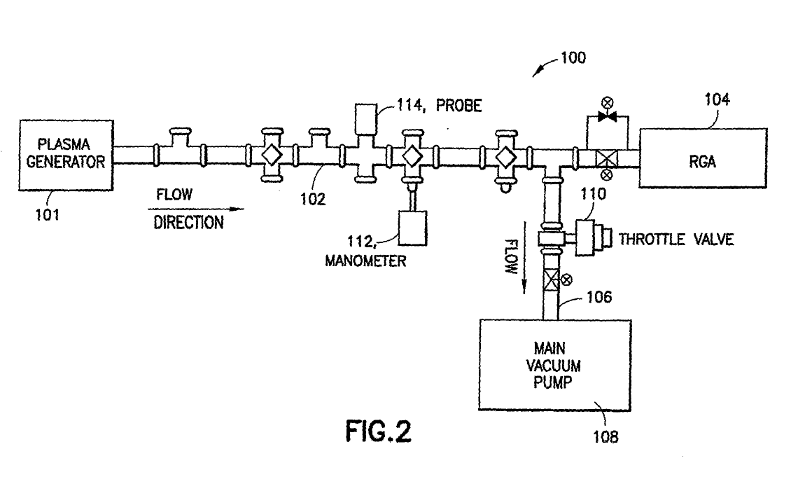

Response characteristics were first examined on a plasma test manifold 100 as systematically shown in FIG. 2. The test manifold included a plasma generator 101 at an upstream end of the manifold conduit 102 and a residual gas monitor 104 at an opposite end of the conduit. The manifold conduit 102 at a downstream portion thereof was coupled to evacuation conduit 106, with the evacuation conduit in turn containing throttle valve 110 and being joined to main vacuum pump 108. The manifold conduit 102 contained a manometer 112 downstream of the probe 114.

The plasma generator 102 was an ASTRON AX7650 Atomic Fluorine Generator. Mass flow controllers (not shown in FIG. 2) were used to control process gas flows through the manifold. The manifold conduit 102 associated with the plasma generator 101 was formed of 6061-T6 aluminum. Multiple KF25 and KF40 ports were provided along the manifold conduit 102 for specimen loading and instrument installation. One port was outfitted with a sapphire window to facilitate visual inspection of sample placement and optical diagnostic instrumentation. An infrared thermocouple, with a spectral response range of 2 to 20 μm, and targeted at the sample surface through a sapphire window, was used to perform infrared pyrometry for tungsten specimens and to measure integrated infrared chemiluminescence for silicon.

A capacitance manometer 112 was used to provide pressure readings and a throttle valve 110 was used to control the pressure in the manifold conduit 102. The residual gas analyzer (RGA) 104 was a RGA300 Residual Gas Analyzer (Stanford Research Systems, Palo Alto, Calif.) was used to monitor the temporal evolution of chemical species.

Probe operation was carried out on production tools, including operation on an Applied Materials Precision 5000 PECVD system (Applied Materials, Inc., Tustin Calif.) running in situ clean processes, and operation on an AKT 15K PECVD system running both remote and in situ clean processes.

Experiments were carried out on the test manifold 100 shown in FIG. 2, to evaluate probe operation with small size specimens, and with an infrared thermocouple being positioned to focus on the specimen in each instance.

A tungsten specimen was disposed in the manifold conduit 102 and subjected to exposure to a cleaning stream derived from a nitrogen trifluoride plasma, to demonstrate operation representative of remote plasma cleaning of tungsten CVD deposits.

The manifold 100 was also operated with an SiO₂/Si specimen disposed in the manifold conduit 102, to demonstrate operation representative of remote plasma cleaning of Si-based materials deposits, and the ability to detect etching through a SiO₂/Si heterojunction.

To demonstrate operation of the calorimetric probe in a production setting, the calorimetric probe was installed on each of two distinctly different PECVD tools. The first tool was an Applied Materials Precision 5000 CVD system running experimental nitride and TEOS-oxide deposition and in situ plasma clean processes. The second tool was an AKT 15K PECVD system running oxide deposition and remote plasma clean processes. In each case, the calorimetric probe was installed between the chamber isolation valve and the throttle valve.

To evaluate in situ cleans of silicon nitride deposits, several experimental silicon nitride depositions were performed on the Precision 5000 system. The deposition time was fixed at two minutes, but other deposition settings varied from one deposition to the next. Each deposition was followed by an in situ clean cycle with fixed process parameters except the clean time. The clean process was manually terminated by the tool operator after the radio frequency (RF) impedance tuning and the calorimetric probe readings both exhibited their characteristic endpoint features, and in some instances operation was continued for an intentionally extended period to determine whether the chamber condition evolved further beyond the identified endpoint.

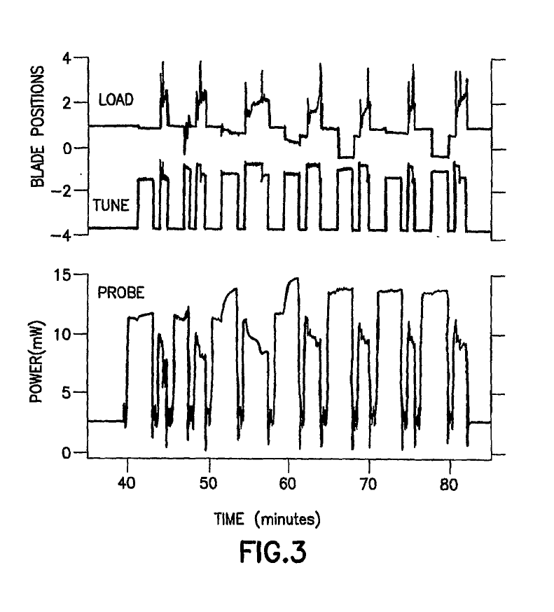

The RF impedance tuning—represented by positions of the load blade and the tune blade—and the calorimetric probe power traces are shown in FIG. 3. The grayed-out areas mark the clean cycles. When the dielectric deposit is nearly removed from the conductive chamber interior, both blade positions moved abruptly to accommodate the rapid change of plasma impedance. The calorimetric probe power also exhibited a sudden reduction in response to rapid change in heat convection loss to the effluent. While each clean trace was unique because each deposition condition was different, the correlation between impedance tuning and calorimetric probe power draw remained well established in all deposition-clean cycles.

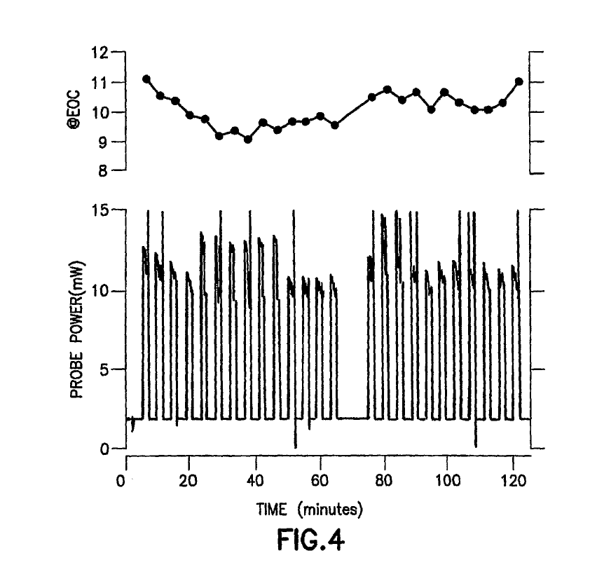

Next, in situ cleans of silicon oxide deposits were conducted, with a repeatability test carried out by performing nominally identical deposition-clean cycles over a cassette of twenty-five wafers. The target material was TEOS (tetraethyl orthosilicate) oxide. The deposition time was fixed at 60 seconds. Each deposition was followed by a 110-second in situ clean cycle. Experiences from earlier experiments suggested that 110 seconds was sufficiently long to ensure that the chamber returned to a clean state after the clean cycle; thus, the chamber was intentionally over-cleaned to support the repeatability test. The results are shown in FIG. 4.

The time gap between the 14^{th} and 15^{th} deposition-clean cycles shown in FIG. 4 is a Precision 5000 convention. The power extrusions are artifacts related to occasional slips in feedback control and occurred after the clean cycles were terminated. While characteristic endpoint features are apparent in each clean cycle, the signal traces do not always resemble one another. In respect of the behavior of the trace during the cleaning process, the probe power at the end of clean (EOC) may be selected as an indicator of the chamber cleanness at the end of clean, and probe power can therefore be used as an input parameter for statistical process control.

A further test was performed on combined cleans of silicon oxide deposits, on an AKT 15K system. The target material was oxide based on SiH₄ silane chemistry. The deposition was followed by a clean cycle with fluorine radicals sourced by remote plasma. An in situ plasma was also maintained throughout the clean cycle. The throttle valve was fully open during the entire clean cycle and the chamber pressure varied as the chamber clean progressed. The clean cycle time was fixed at 15 minutes.

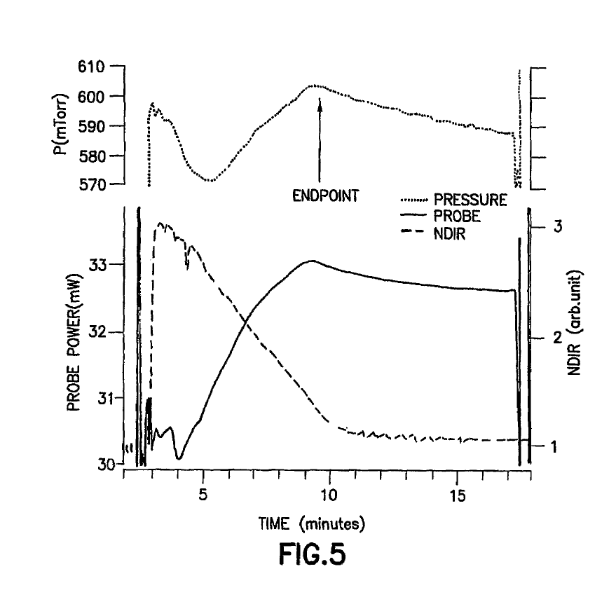

A non-dispersive infrared (NDIR) sensor for SiF₄ detection was co-installed with the calorimetric probe for comparison study. To facilitate NDIR detection, an effluent split-stream was routed from the main exhaust line to pass in front of the sensor cell and subsequently return to the exhaust line. A separation valve protected the sensor cell from reaction chemistry during the deposition cycle. The results are shown in FIG. 5.

The pressure profile is included in FIG. 5 to assist data interpretation as characteristic endpoint features—marked by an arrow in the chart—have been empirically identified.

SiF₄ abundance in the effluent, as represented by NDIR signal strength, rose immediately after the start of the cleaning operation and subsequently declined to a plateau past the apparent endpoint. The calorimetric probe power exhibited a stabilization period initially, which was attributed to turbulence caused by opening of the NDIR separation valve. The calorimetric probe power subsequently rose to a plateau, which appeared to closely follow the pressure profile including the characteristic endpoint features and beyond. The time difference between endpoints determined by the calorimetric probe, which was in close proximity to that indicated by the pressure profile, and by the NDIR sensor, were approximately one minute.

The foregoing results thus evidence the utility of the invention in the provision of a calorimetric probe that is immersion in the plasma effluent to measure the heat flux carried by the effluent, for sensing of the endpoint of the plasma cleaning operation corresponding to a transition of the thermal characteristic of the plasma effluent. Etching behaviors of W and SiO₂/Si specimens were evaluated using a test manifold and chamber cleaning of silicon nitride and oxide using production tools, and successful endpointing was demonstrated for both in situ and remote chamber cleaning processes.

### Example II

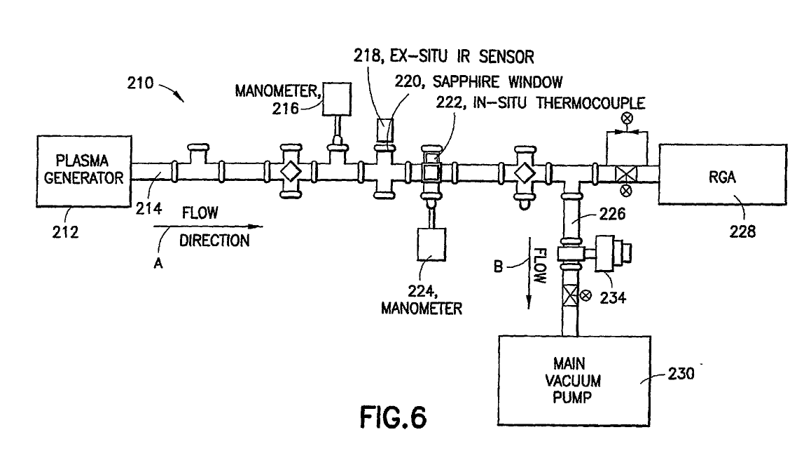

The fluorine plasma test manifold shown in FIG. 2 was modified to the configuration shown in FIG. 6, for the purpose of evaluating the measurement of temperature of the plasma effluent ex situ, through an optical window.

The modified manifold 210 included a main conduit 214 coupled at a first end with plasma generator 212 and coupled at a second end with residual gas analyzer 228. The main conduit 214 at a downstream portion thereof was coupled with a vacuum line 226. The vacuum line 226 was joined in turn to main vacuum pump 230 and contained throttle valve 234. Flows of the plasma effluent through the main conduit 214 and through the vacuum line 226 are indicated by arrows A and B, respectively.

An infrared temperature sensor 218 (Omega Engineering Model No. OS37-CF) operating at wavelengths compatible with a sapphire window was mounted in sensing relationship to sapphire window 220, to provide an output equivalent to a K-type thermocouple signal. A T-type thermocouple 222 was installed on the fluorine plasma test manifold as shown in FIG. 6, and a manometer 224 was installed at the same section of the main conduit 214, for pressure monitoring.

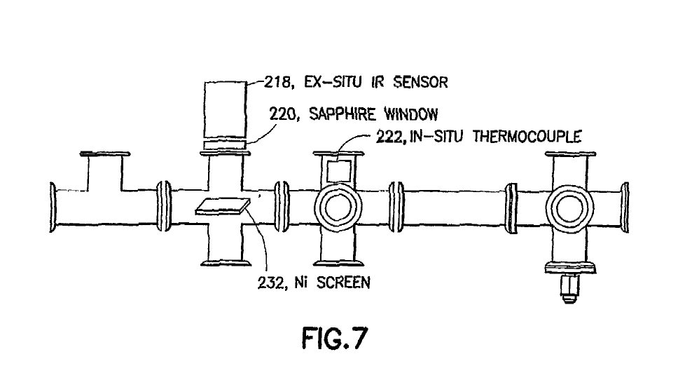

The infrared temperature sensor 218 work best when measuring a surface with a high emissivity (non-metal or coated metal). An initial effort was made to measure to measure the interior wall of the test manifold, but no change in temperature was observed with NF₃ plasma. A small, thin piece of highly dense mesh nickel screen material was then inserted about 2 to 3 inches below the sapphire window 220 in the gas stream to serve as a target that would be heated by the NF₃ plasma to produce a temperature change large enough to measure with the IR sensor. The placement of the nickel target 232 is shown in FIG. 7. The test manifold 210 also featured an NF₃ mass flow controller (not shown in FIG. 6 or 7).

The test manifold 210 was programmed to simulate 3 deposition/cleaning cycles with a timing of 60 seconds for deposition and 180 seconds for cleaning. Midway through each clean cycle, the NF₃ plasma was ramped up to force a rise in the F₂ concentration and simulate an endpoint clean condition. The NF₃ mass flow controller installed on the manifold 210 was a 5 liter controller, and exhibited a large overshoot whenever NF₃ was initially turned on, as is reflected in the plots of the data.

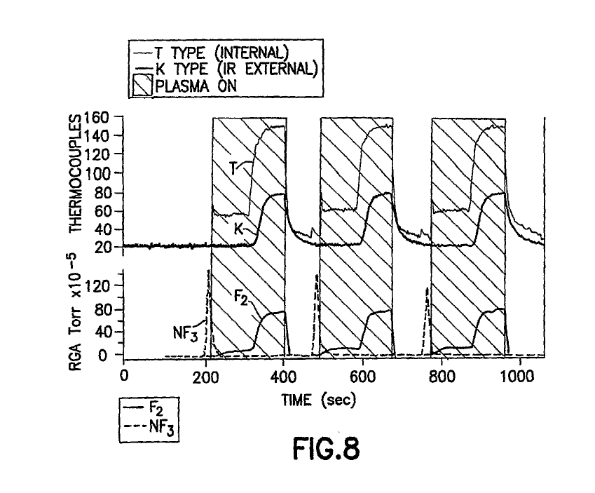

The infrared temperature detection was successfully demonstrated, detecting a temperature rise in the nickel target. The temperature rise reflected a slight time lag as compared to the in-situ T-type thermocouple 222, which was attributed to the thermal time constant associated with the larger mass of the nickel target. The results of the test are shown in FIG. 8.

### Example III

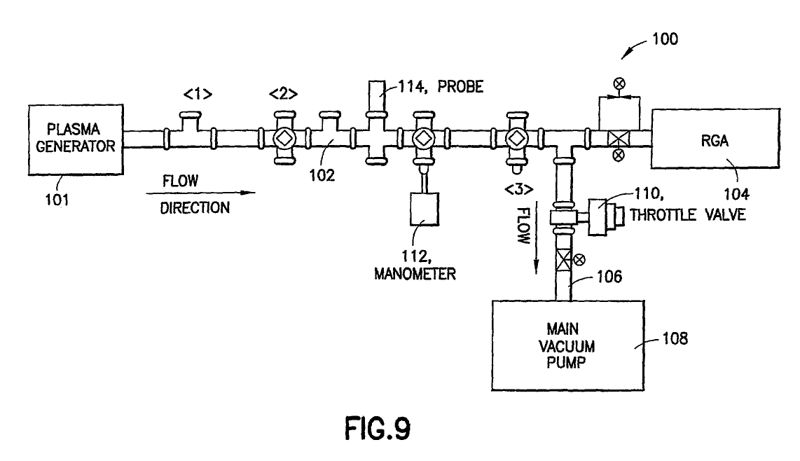

In this example, the test manifold of FIG. 2 was utilized, with temperature monitoring sites provided as identified in FIG. 9, to evaluate infrared pyrometry on a SiO₂/Si specimen during NF₃ etching. All parts and components in the FIG. 8 drawing are numbered correspondingly with respect to the same parts and components in the FIG. 2 drawing.

A square SiO₂/Si specimen was used, which when placed in the transport tube, occupied nearly the full view of a KF40 sapphire window. The SiO₂ layer was 2 μm thick. A wide-view (30°) infrared pyrometer 218, Omega OS37-CF-K, exhibiting a voltage output that mimics a K-type thermocouple, was placed on the sapphire window 220 and looked directly at the SiO₂/Si specimen. The uncompensated voltage output was logged and a DMM with a K-type thermocouple readout was monitored for temperature reading. The following thermal monitoring probe locations were utilized, with the KF25 (Lorex KF25 was a filament-based endpoint monitor (ATMI, Inc., Danbury, Conn., USA)) and T-type thermocouple located downstream of the SiO₂/Si specimen, as identified in FIG. 9:

<1>pyrometer (and the specimen);

### <2>Lorex KF25; and

<3>T-type thermocouple.

The test manifold was operated in a four-step process, including four NF₃ pulses in a constant background of 1000 sccm argon. Four high NF₃ flows were employed: 800, 200, 600, and 400 sccm flows.

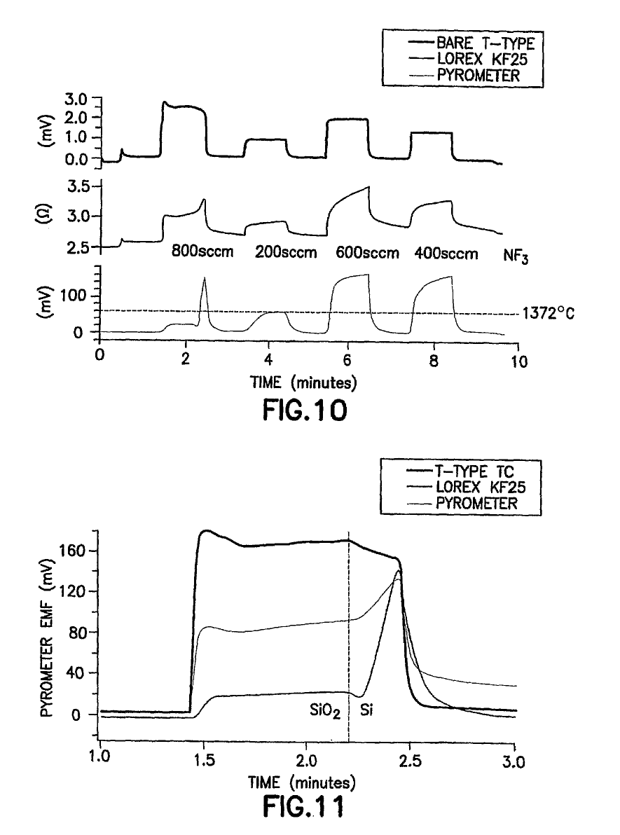

The Lorex KF25 thermocouple was used as an endpoint monitoring reference. Data traces from the three devices <1>, <2> and <3> are shown in FIG. 10, which is a graph of the outputs of three temperature monitoring devices, the pyrometer, in millivolts, the Lorex KF25 thermocouple, in ohms, and the bare T-type thermocouple, in millivolts, as a function of time, during consecutive nitrogen trifluoride pulses. The output of the infrared pyrometer is shown with a dashed line in the plot, reflecting the upper range limit of the device, 1370° C. (K-type thermocouple limit), which corresponds to an EFM of 54.886 mV.

FIG. 11 is a graph showing the superimposed traces of the graph of FIG. 10 during the first NF₃ pulse. The first plateau (at approximately 570° C.) corresponded to the removal of SiO₂ from the SiO₂ layer. As the silicon surface was subsequently exposed, the surface temperature correspondingly increased. This phenomenon of silicon surface exposure explained why the output level for the 800 sccm NF₃ pulse was, except for a rapid increase towards the end of the pulse, lower than subsequent pulses of lower NF₃ flows.

Considering now the thermal balance of an element immersed in the effluent stream, the following heat balance equation is applicable:

<Joule heating>+<exothermic reactions>+<heat transfer to contacts>+<heat transfer to effluent>+<radiation>=0

The contribution from exothermic reactions, involving exothermic recombination of fluorine radicals in the case of NF₃ cleaning, depends on the reaction rate and the abundance of fluorine radicals. Heat transfer to the contacts is small, and it scales with the temperature difference between the element and the ambient. Heat transfer to the effluent is dominated by heat convection. Radiation is also small within the element temperature of interest. With these simplifications, the thermal balance equation becomes

$$\begin{matrix}[ F ] \cdot r + k \cdot h \cdot ( {T}_{effluent} - {T}_{element} ) \approx 0 \\ ⇒ {T}_{element} \approx {T}_{effluent} + \frac{[ F ] \cdot r}{k \cdot h}\end{matrix} thermocouple$$

$$\begin{matrix}{I}^{2} R + [ F ] \cdot r + k \cdot h \cdot ( {T}_{effluent} - {T}_{element} ) \approx 0 \\ ⇒ {T}_{element} \approx {T}_{effluent} + \frac{{I}^{2} R + [ F ] \cdot r}{k \cdot h}\end{matrix} heated filament$$

where r is the reaction, and k and h are the thermal conductivity and the convectional heat transfer coefficient of the effluent. While all terms have different values between the thermocouple and the heated filament, the relevant difference is that the filament self-heats, but the thermocouple does not.

Considering now the T-type thermocouple response, it is noted that at the SiO₂/Si transition, the thermocouple temperature decreased. Although this appears to be a counter-intuitive behavior, based on expectation that a hotter specimen surface would release heat into the effluent and therefore raise the effluent temperature, it must be borne in mind that the effluent at this time became more abundant in SiF₄ (a low thermal-conductivity gas). Mathematically,

$${T}_{element} ↓ \approx {T}_{effluent} ↑ + \frac{[ F ] \cdot r}{k ↓ \cdot h ↓}$$

The only solution to balance this equation is to achieve a reduced [F], which is consistent with the faster etch rate of silicon as compared with that of oxide.

Considering now the thermal balance equation for the infrared pyrometry endpoint monitoring,

$${T}_{element} ↑ \approx {T}_{effluent} ↑ + \frac{{I}^{2} R + [ F ] ↓ \cdot r}{k ↓ \cdot h ↓} ,$$

this balance holds when Joule heating more than compensates the reduced exothermic reactions.

It will be apparent from the foregoing that the specimen surface temperature is extremely hot when silicon is being etched, and less so (˜570° C.) when oxide is being etched. Both the infrared pyrometer and the thermocouple exhibited signal transition when the oxide was etched through and the underlying silicon surface was exposed.

Another aspect of the invention relates to an endpoint monitor sensor element including a Ni-coated SiC filament. One of the operational issues associated with such sensor element is that its electrical resistance is small and this characteristic imposes significant demands on system instrumentation. The small electrical resistance is attributable to electrical conduction through the Ni metal. The invention addresses such issue by providing endpoint monitoring sensors in which the Ni coating is removed from the electrical conducting path.

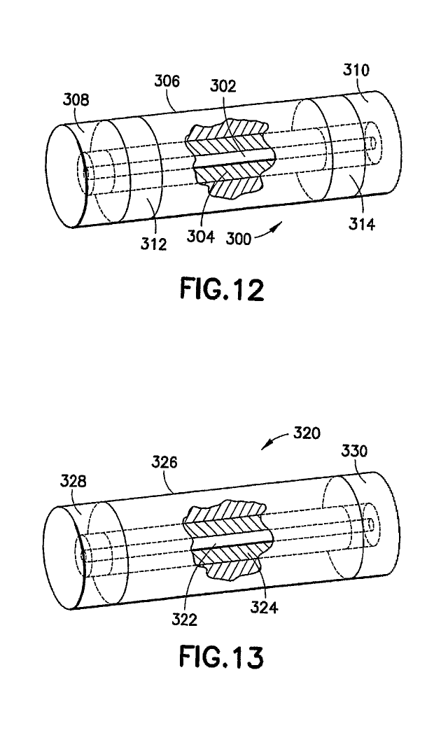

FIG. 12 is a schematic perspective view of an endpoint monitor sensor element 300 according to one embodiment of this invention, in which the nickel coating of the Ni-coated filament is electrically isolated. This sensor element illustrates that Ni catalyst can be removed locally to isolate the conducting catalyst from electrical conduction.

As shown in FIG. 12, the endpoint monitor sensor element 300 includes an amorphous carbon monofilament 302 within a silicon carbide (SiC) cylindrical body 304. The cylindrical body 304 is encased in a nickel sheath 306 including a main longitudinal sheath portion and respective first end portion 308 and second end portion 310.

The sheath 306 is discontinuous in proximity to its first and second end portions, forming respective first and second circumferentially extending grooves. The first groove adjacent the first end portion 308 contains a first annular insulator member 312, and the second groove adjacent the second end portion 310 contains a second annular insulator member 314.

The grooves and annular insulator members disposed therein may be formed in any suitable manner.

In one approach, the annular insulator members may be preformed, and are slid into place on the silicon carbide cylindrical body 304 before nickel is overcoated on the main length portion of the SiC cylindrical body and on the end portions.

In another approach, the nickel is deposited on the full length of the silicon carbide cylindrical body 304 and beyond the ends of such body, following which the nickel is masked and selectively etched away to form the first and second circumferentially extending grooves. Subsequent to formation of the grooves, the grooves are filled with the insulator material to form the structure as shown in FIG. 12.

In the operation of the endpoint monitor sensor element 300 when installed as a component of an endpoint sensor assembly, the signal transduction is conducted by the amorphous carbon monofilament 302 which has a [(resistance)×(temperature coefficient)] product, referred to for ease of reference as the RTC parameter, that is on the order of 10 times larger than the RTC parameter of a corresponding Ni-coated silicon carbide filament.

By the structure shown in FIG. 12, the main longitudinal sheath portion of the nickel sheath is electrically isolated by the insulator members 312 and 314. The nickel coating at the first end portion 308 and second end portion 310 are utilized for making electrical contact with the a conducting core of the sensor element. The isolation can be achieved by, for example, selective coating of Ni or laser removal of a blanket Ni coating on the SiC cylindrical body 304 to form the grooves to be filled with an insulator material, preferably an insulative medium that is fluorine-resistant in character.

The insulator material can be of any suitable type, e.g., a glass, ceramic or polymeric insulation medium. In a preferred embodiment, the insulator material includes a fluorocarbon polymer, such as for example polytetrafluoroethylene (PTFE).

FIG. 13 is a schematic perspective view of an endpoint monitor sensor element 320 according to another embodiment of this invention, in which the nickel coating of the Ni-coated filament is electrically isolated. FIG. 13 illustrates the use of an insulating “catalyst” on a conducting core, with the Ni coating at the ends are for making electrical contact to the conducting core.

As shown in FIG. 13, the endpoint monitor sensor element 320 includes an amorphous carbon monofilament 322 within a silicon carbide (SiC) cylindrical body 324. The cylindrical body 324 is encased in a sheath 326. The sheath 326 is formed of an insulator material, which may be of a same type as the insulator described in connection with the embodiment of FIG. 12.

The sheath portion of the sensor element has a diameter that is coextensive with the diameter of the respective end portions 328 and 330, each of which is formed of nickel or other suitable conductive material. The sheath portion of the sensor element in FIG. 13 is advantageously formed of a fully fluorinated polymer such as polytetrafluoroethylene.

For the pressure/flow conditions that are used for chamber cleans, fluorine recombination does not appear to depend on the flow channel material of construction, among the fabrication materials of aluminum, polytetrafluoroethylene, and nickel. Indeed, it has been found that the signal strength of aluminum, copper, and nickel filaments can be largely attributed to their respective resistivity and temperature coefficient of resistivity, which indicates that the catalytic function is comparable among these three metals. These results suggest that one may replace Ni by an insulating fluorine-resistant material such as polytetrafluoroethylene or other fully fluorinated polymer. In addition, other and more resistive core materials than amorphous carbon filament can be used.

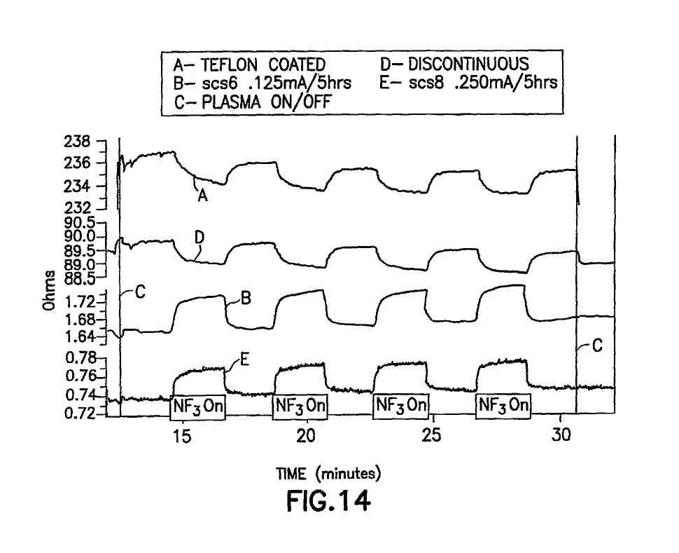

FIG. 14 is a graph of resistance, in ohms, as a function of time, in minutes, showing the response of a Teflon-coated nickel plated SiC filament (curve A), a discontinuous nickel plated silicon carbide filament (curve D), a nickel plated SiC filament plated at a current of 0.125 milliamps for 5 hours (curve B) and a nickel plated SiC filament plated at 0.25 milliamps for 5 hours (curve E), with curve C representing the plasma on/off cycle. The test conditions involve simultaneously testing all four filaments in a constant current mode. Process conditions included a pressure of 5 torr with a flow rate of 800 standard cubic centimeters per minute (sccm) of argon and 400 sccm nitrogen trifluoride, with the process being operated by turning on and off four times to simulate endpoint or fluorine rise.

It was observed that the Teflon coated sample and the discontinuously coated filament had opposite responses. Resistance (R) decreased with the introduction of fluorine.

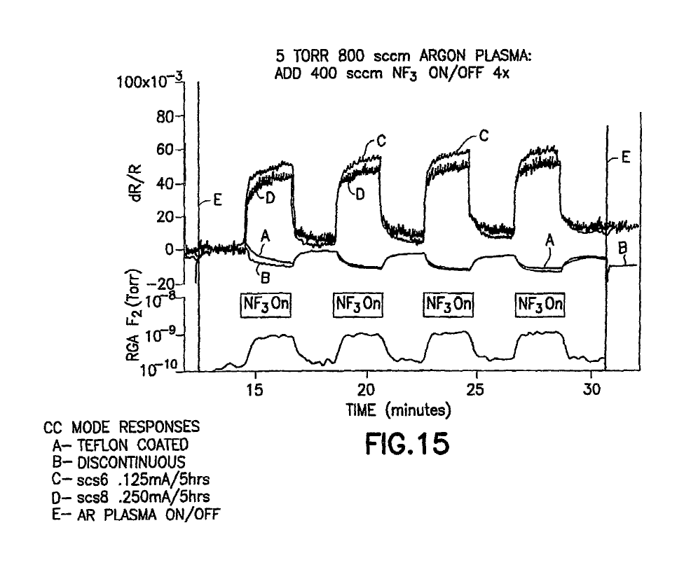

FIG. 15 is a corresponding graph of the signal response as dR/R as a function of time, in minutes, showing that the Teflon® coated element and discontinuous element had the lowest dR/R values.

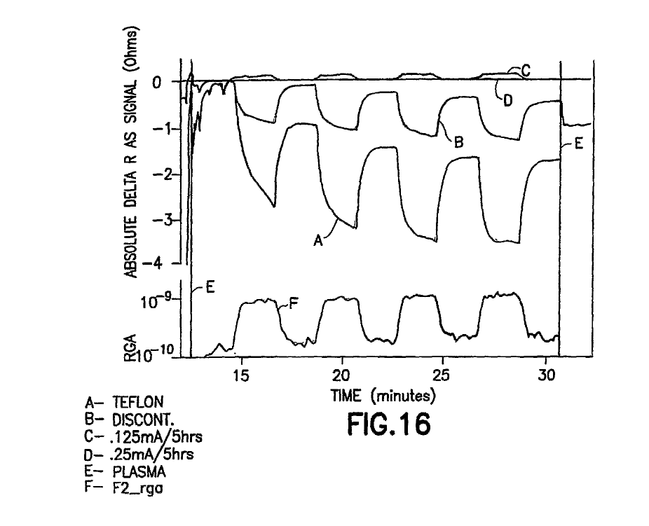

FIG. 16 is a corresponding graph of the absolute delta R (dR) as a signal, in ohms, as a function of time, in minutes. FIG. 16 shows that the Teflon® coated element and discontinuous element had the highest signal strength.

Thus, the invention contemplates an endpoint monitor sensor element including an amorphous carbon filament within a silicon carbide cylindrical body, wherein the silicon carbide cylindrical body is encased in a nickel sheath, such nickel sheath including end portions adapted to contact an electrical power supply circuit, and a main longitudinal sheath portion isolated from electrical conduction with the end portions by an isolation structure.

The isolation structure can be of any suitable type. In one embodiment, the isolation structure includes annular insulation rings interposed between the end portions and the main longitudinal sheath portion. The annular insulation rings can be formed of a suitable insulating material such as a fluoropolymer, e.g., polytetrafluoroethylene.

The invention also contemplates an endpoint monitor sensor element including an amorphous carbon filament within a silicon carbide cylindrical body, wherein the silicon carbide cylindrical body is coupled at end portions thereof with nickel contacts, and the silicon carbide cylindrical body along a main longitudinal length intermediate the end portions is encased in an insulative sheath. The insulative sheath can likewise be formed of an insulative material such as a fluoropolymer, e.g., polytetrafluoroethylene. The insulative sheath in a preferred embodiment is coextensive in diameter with the nickel contacts.

The endpoint monitor sensor elements described above can be incorporated in endpoint monitors of widely varying types.

The invention further contemplates a process installation including a chamber requiring cleaning and an endpoint monitor including such endpoint monitor sensor element, as well as a method of monitoring a process chamber clean, comprising use of an endpoint monitor of such character, as well as a process installation including a chamber requiring cleaning and an endpoint monitor of such type adapted to monitor the cleaning.

In another aspect, the invention provides a method of conducting a clean process including flow of a cleaning medium through a process chamber to remove deposits from the chamber and discharge a cleaning medium effluent from the chamber, such method comprising: monitoring power as a function of time during the clean process; and determining an endpoint of the clean process as occurring when the monitored power as a function of time transitions in trace form to a plateau character. This method in a specific embodiment further includes terminating the clean process upon endpoint determination.

The invention in a further embodiment provides a method of conducting a clean process including flow of a cleaning medium through a process chamber to remove deposits from the chamber and discharge a cleaning medium effluent from the chamber, such method comprising: monitoring power as a function of time during the clean process and generating a corresponding signal including a true signal and a noise component; and determining an endpoint of the clean process as occurring when magnitude of the noise component is at least equal to temporal change of the true signal.

The determining operation in the above-described methodology can involve determining a difference between a median of signal values for multiple prior signal samplings and a current signal value, and/or signal processing including computation of a median filter difference function and a confidence level counter function.

A further aspect of the invention relates to a process installation including a chamber requiring cleaning and an endpoint monitor adapted to monitor the cleaning by one of the above-described methods. The process chamber can be of any suitable type, e.g., a chamber of a semiconductor manufacturing tool, such as a chemical vapor deposition chamber.

The process installation can further include a plasma generator for plasma cleaning, e.g., arranged for remote plasma generation to form cleaning species for clean of the chamber, so that the process chamber is cleaned of deposits from a deposition process conducted therein.

The cleaning medium can be of any suitable type, e.g., an NF₃ plasma, a cleaning medium containing ionic species, a cleaning medium containing fluoro species, etc.

In another aspect, the invention relates to endpointing algorithms and techniques for determining the conclusion of cleaning of a process chamber. Each tool and process has a unique response trace under a specific set of process conditions that may be exploited in this effort.

This aspect of the invention utilizes a toolbox of simple physics-based, as opposed to mathematics-based, algorithms targeting different scenarios, and a chooser algorithm. A regional trace characteristics approach is now described, illustrative of one embodiment of the invention.

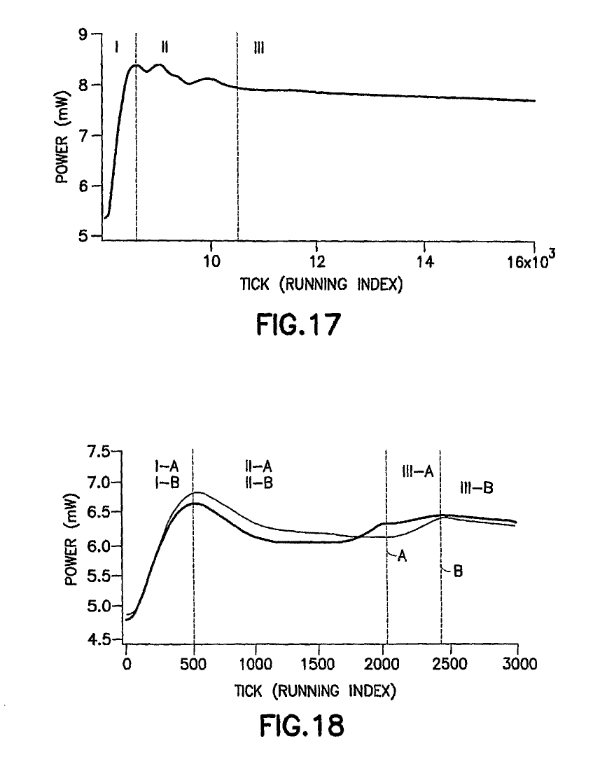

An algorithm, complementary to a generalized Δmax algorithm, is developed in the ensuing discussion, for response traces having certain traits. A sample response trace is shown in FIG. 17 to facilitate the discussion. Three regions are identified with the trace: Region I is a starting transient, Region II is a cleaning signature, and Region III is a post-ending signature. Such a region designation is universally applicable. Note that Region II may be absent if an already clean chamber is being cleaned, and Region III may be absent if the chamber is not cleaned sufficiently.

Region I almost always involves a ramping up of power regardless of the tool or the process that is involved. Such behavior occurs due to increase of gas flow and pressure during the starting transient from base vacuum condition (to clear the chamber for cleaning) to the actual chamber clean, thereby promoting heat loss to the effluent and correspondingly indicating the need for additional Joule heating. As such, the rising trend is near-universal and contains little information about the clean process. The Δmax algorithm assumes that Region I ends at the peak of the entire clean trace and correspondingly bypasses Region I and captures the Region II response pattern.

The Region II trace corresponds to process chamber conditioning during deposit removal, and thus is specific to a given tool or process. The trace behavior is not known a priori, but an explicit correlation between the trace characteristics and the tool or process is often observed. By way of specific example, the traces for silicon, oxide, and nitride clean processes on all AKT 4300 plasma enhanced chemical vapor deposition tools, commercially available from AKT, Inc. (Santa Clara, Calif.) have a unique signature. This signature reflects the thermal conductivity of the byproducts and enthalpy of the etching reaction.

Region III trace corresponds to cleaning a clean chamber and therefore, ideally, does not depend on the identity of the deposit material. It still depends on the tool configuration and process details, but generally assumes the form of a sloped plateau.

Considering Region II and the Δmax algorithm in greater detail, the generalized Δmax algorithm assumes certain traits in Region II, and reduces the endpointing problem to a matter of identifying the point in time, namely, the endpoint, when the traits disappear. When translated to chamber conditioning, the traits assume the chamber conditioning is—to a large extent—spatially (around the chamber interior and through the deposit thickness) and temporally homogenous. Coupled with device physics, this assumption bounds the trace appearance to one of the following four possibilities shown in Table I below: [symbol] rising, [symbol] falling, [symbol] falling [symbol] rising, and [symbol] rising [symbol] falling. For the last two scenarios [symbol] and [symbol] the ending point may be higher or lower than the starting point; it is the trending trait that defines the categorization.

TABLE I
Trace Appearances

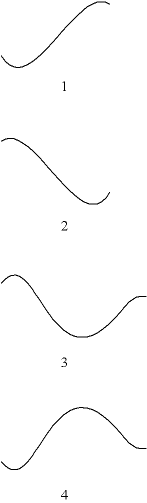

Spatial or temporal inhomogeneity tends to manifest itself in oscillations or “ripples” superimposed on the basic trace. The sample trace of FIG. 17 corresponds to an a-Si:H/SiN bilayer deposit removal process; etching of the bilayer, a spatial inhomogeneity, causes temporal inhomogeneity in effluent temperature and composition and leads to ripples in Region II.

Concerning Region III, an algorithmic approach may be premised on the assumption that the Region III trace is a slow function of time, i.e., plateau-like in character, whereas the Region II trace is not. The start of this slowness therefore indicates the endpoint. This approach reduces the endpointing problem to a matter of identifying the endpoint at which the trace starts to resemble a plateau, and bounds the issue to the algorithmic definition of a plateau. There are a number of valid and applicable approaches to such definition that may be employed for such purpose. Derivative-based algorithms are conceptually straightforward, but can be vulnerable to the presence of noise. Such noise phenomenon can be taken to advantage by loosely defining that a slow function of time is a function for which noise magnitude is comparable to, or greater than, the temporal change of the true signal. A median filter may be employed for such purpose, in defining the following difference function:

Δx[n]=|Median(x[n−span,n])−x[n])

where Median is the median function. When the trace varies rapidly, the difference between the median value of the last several readings and a current reading is typically large because the signal change is large compared to noise. Conversely, there is a high probability, since noise is a statistical phenomenon, that the prescribed difference is small when the function is slow. The confidence level may be represented by the following counter function:

$$N [ n ] = max ( 0 , N [ n - 1 ] + count ) ; count = \{ \begin{matrix}+ 1 & Δ x [ n ] < noise \\ 0 & Δ x [ n ] = noise \\ - 1 & Δ x [ n ] > noise\end{matrix}$$

This function is defined in a recursive manner and is either zero or positive. A small N[n] value indicates that the function is a temporally fast function, while a large N[n] value provides a high confidence that the function is slow varying in time. This “largeness” can be detected by a convectional threshold trigger, and the threshold value can be determined through “training” as part of the installation procedure.

Specific to the traces illustratively set out herein, the following parameter values are chosen: span=2 and noise=1 μW. Span is preferably an even number to avoid signal averaging; 2 is chosen because it is the smallest even number. Large span builds confidence but delays endpoint calling. The noise magnitude should be realistic, i.e., chosen to reflect what is experimentally observed. The lowest meaningful noise value would be the nominal data resolution because any noise below the resolution limit cannot be experimentally observed. The resolution limit of 1 μW is chosen for use in the present data set.

The application of this Region III algorithm to illustrative tool clean data for a Si:H/SiN process is now described, for an AKT 15k tool, for which three data sets, 15k_{—}1, 15k_{—}2, and 15k_{—}3 were accumulated. With a single exception of an oxide deposit (which faulted out), all successful processes were remote NF₃ cleans of silicon/silicon nitride deposits.

The first data set cycles (15k_{—}1.txt: Cycles 1 through 4) involved a Setpoint on the Fly=Active, and the sample rate was ˜40 Hz. The first clean was done on an already clean chamber and the end point monitor went into an unstable oscillation, which was then stabilized by a PID control. The clean cycle was 200 seconds. The depositions involved 60 seconds of amorphous Si deposition followed by 60 seconds of SiN deposition.

This scenario was accommodated by a Region III algorithm. For the data set, the PID oscillation was temporally fast compared to the tailing trace in Region III. The spatial inhomogeneity of a-Si:H/SiN bi-layer introduced some temporally fast traits in Region II, which indicated the desirability of applying a Region III algorithm. The endpoint times of the three later cycles were generally consistent. The results are shown below in Table II.

TABLE II

Cycle

| | 1 | 2 | 3 | 4 |
|---|---|---|---|---|
| Clean time (seconds) | 192 | 203 | 203 | 202 |
| Endpoint (seconds) | 84 | 60 | 65 | 62 |

The second data set cycle (15k_{—}2.txt: Cycle 5) involved issue of a START command about 8-10 seconds late for this cycle. As a result, the chosen setpoint was different, there were fewer oscillations in the signal near the start of the clean, and the overall power was lower. A STOP command was also issued late, resulting in a transient at the end of clean. Since the clean time is determined by the START and STOP commands, the effects of a late START and a late STOP rendered the apparent clean time little changed. Considering that the apparent endpoint time was affected by the late start, the difference of 30 seconds between this and earlier cycles resulted in the algorithm calling an early apparent endpoint because Region II had an early plateau. The results, including earlier cycles 1-4, are tabulated in Table III below.

TABLE III

| | Cycle | | | | |
|---|---|---|---|---|---|
| | 1 | 2 | 3 | 4 | 5 |
| Clean time (seconds) | 192 | 203 | 203 | 202 | 196 |
| Endpoint (seconds) | 84 | 60 | 65 | 62 | 33 |

The second data set cycle (15k_{—}3.txt: Cycles 6-12) involved formulations intended to give a thicker deposition than those used in prior cycles. The CLEAN period was extended to be 260 seconds in duration, the a-Si deposition was 60 seconds in duration, and the SiN deposition was 120 seconds in duration. Since each CLEAN of a given recipe involved cleaning a previous deposition, clean cycle 6 involved cleaning a nearly clean chamber. Clean cycles 7 and 8 involved cleaning the thicker depositions. Recipe cycles 8 and 9 were nominally the same as cycles 2, 3 and 4. Recipe cycles 10, 11 and 12 involved shortening the cleaning time to 140 seconds, with the deposition periods maintained the same.

The two cycles involving thicker deposits, cycles 7 and 8, required a higher confidence threshold (50 instead of 15 used earlier). The thicker SiN deposit introduced a longer period of spatial homogeneity, which was discounted (by a higher threshold) in order to call a correct endpoint, as a tradeoff between confidence and timeliness.

The results, using cycle-appropriate thresholds, are tabulated below in Table IV.

TABLE IV

| | Cycle | | | | | | | | | | | |
|---|---|---|---|---|---|---|---|---|---|---|---|---|
| | 1 | 2 | 3 | 4 | 5 | 6 | 7 | 8 | 9 | 10 | 11 | 12 |
| Clean time | 192 | 203 | 203 | 202 | 196 | 270 | 267 | 204 | 206 | 146 | 146 | 145 |
| (seconds) | | | | | | | | | | | | |
| Endpoint | 84 | 60 | 65 | 62 | 33 | 46 | 88 | 80 | 41 | 40 | 42 | 44 |
| (seconds) | | | | | | | | | | | | |

Cycles 2 through 4 and 9 through 12 did not resemble one another even though the end point monitor experienced nominally identical deposition and clean processes. The algorithm identified the endpoint as defined, but cycles 2 through 4 did not have any plateau in Region II whereas the latter cycles all had such a plateau.

For the 12-trace data set, the power traces ranged from 5 mW to more than 12 mW for nominally identical clean processes. The resistance control setpoint was chosen during the starting transient, and the setpoint value therefore was not repeatable from cycle to cycle. At low setpoint values, the end point monitor response tended to reflect the presence of radical recombination. When setpoint value was high, end point monitor response correlated better with thermal conductivity of the effluent. The trace characteristics therefore depended on the setpoint chosen. Because the applicability of the endpointing algorithm is closely tied to the trace characteristics, it is desirable to choose a fixed setpoint so that the algorithm chosen will work for all traces.

As a further example involving SiN deposition using an AKT 4300 tool (commercially available from AKT, Inc., Santa Clara, Calif., USA), the region designation of two representative AKT 4300 SiN process traces, corresponding to two SiN deposit thicknesses, is shown in FIG. 18, in which the heavier line represents a first trace (trace A) and the lighter line represents a second trace (trace B), with the respective Regions I, II and III for the associated traces being suffixed by the appropriate trace designation (A, B). The crossover between Regions I and II is identified by the local maximum. The crossover between Regions II and III is less apparent but can be identified by comparing the features of the two traces. The extended Region II plateau discourages the application of a Region III algorithm.

A 10 cycle SiN process and clean was conducted using an AKT 4300 tool. The standard recipe for cycles 1-8 was a 300 seconds SiN deposition and a 240 seconds NF₃ clean. Cycle 9 involved a 360 seconds deposition and a 300 seconds clean. Data was recorded for the cleans only. In the clean in cycle 5, the microwave plasma generator malfunctioned and the clean process was aborted, and the clean in cycle 6 was a partial clean as a consequence. A customized Δ(Δmax) algorithm was applied. The results are tabulated in Table V below.

TABLE V

| | Cycle | | | | | | | | |
|---|---|---|---|---|---|---|---|---|---|
| | 1 | 2 | 3 | 4 | 5 | 6 | 7 | 8 | 9 |
| Clean time (seconds) | 250 | 254 | 235 | 250 | 223 | 157 | 255 | 252 | 311 |
| Endpoint (seconds) | 122 | 121 | 118 | 116 | 122 | | 129 | 127 | 147 |

A 13 cycle SiN process and clean was conducted using an AKT 4300 tool. The operation included (a) 3 clean cycles (cycles 1-3) with a high current idle setting (˜80 mA), (b) 3 clean cycles (cycles 4-6) with a medium idle current (˜40 mA), (c) 1 clean cycle (cycle 7) with a low idle current setting (˜20 mA), (d) 1 clean cycle (cycle 8) at ˜40 mA idle current and a 10 second start delay, (e) 2 cycles (cycles 9-10) at 30 mA idle current and a 10 second start delay, (f) 1 cycle (cycle 11) with a 3.45 ohm fixed setpoint, (g) 1 cycle (cycle 12) with a 3.3 ohm fixed setpoint and start delay=0, started before the microwave plasma ignition, with the microwave ignition causing the endpoint monitor to cool, resulting in a power increase, and (h) 1 cycle (cycle 13) with a 3.2 ohm fixed setpoint and start delay=0, started before the microwave plasma ignition, with the microwave ignition causing the endpoint monitor to cool, resulting in a power increase.

It was found that traces with low resistance setpoint are better processed by a Region II algorithm; those with high resistance setpoint, a Region III algorithm. The preference appeared related to which of the two contributing factors (radical recombination vs. effluent composition) was more influential. Endpoint III results were generally consistent despite wide variation in setpoint values. Thus, a low setpoint typically correlated to low endpoint monitor power and the endpoint monitor was sensitive to enthalpy from radical recombination. A high setpoint typically correlated to high endpoint monitor power and the endpoint monitor was sensitive to heat loss to the effluent. The data for the 13 cycle operation is set out in Table VI below.

TABLE VI

| | Cycle | | | | | | | | | | | | |
|---|---|---|---|---|---|---|---|---|---|---|---|---|---|
| | 1 | 2 | 3 | 4 | 5 | 6 | 7 | 8 | 9 | 10 | 11 | 12 | 13 |
| Clean time (seconds) | 183 | 139 | 183 | 124 | 124 | 125 | 105 | 332 | 96 | 96 | 108 | 137 | 123 |
| Endpoint II (seconds) | | | | | | | 57 | | 78 | 76 | | | |
| Endpoint III (seconds) | 97 | 87 | 85 | 87 | 83 | 86 | | 82 | | | 81 | 99 | 102 |

The foregoing results evidence the need for a high degree of data integrity and consistency in order for reliable signal processing to be achieved. To enable the assumption of heat loss to electrical contacts to be constant, it is necessary to maintain the exhaust line at a constant temperature, or to compensate by controlling the temperature of the electrical contacts, e.g., by application of a modulated heat input to the contacts.

A further aspect of the invention relates to a method of improving process efficiency in a manufacturing process utilizing any endpoint monitor, calorimetric probe, monitoring assembly, and/or endpoint monitor sensor element as described herein. Such manufacturing process include a semiconductor manufacturing process.

In another aspect, the invention relates to a method of manufacturing a product, wherein the manufacturing method includes the step of monitoring a process fluid stream utilizing any endpoint monitor, calorimetric probe, monitoring assembly, and/or endpoint monitor sensor element as described herein. Such product may include a semiconductor.

While certain aspects of the invention have been described herein with reference to cleaning steps and other steps beneficially employed in the manufacture of semiconductors, it is to be appreciated that the invention is equally applicable to generalized monitoring in a process facility.

While the invention has been has been described herein in reference to specific aspects, features and illustrative embodiments, it will be appreciated that the utility of the invention is not thus limited, but rather extends to and encompasses numerous other variations, modifications and alternative embodiments, as will suggest themselves to those of ordinary skill in the field of the present invention, based on the disclosure herein. Correspondingly, the invention as hereinafter claimed is intended to be broadly construed and interpreted, as including all such variations, modifications and alternative embodiments, within its spirit and scope.

1.-131. (canceled)

132. An endpoint monitor adapted to determine an endpoint of a cleaning process in which a cleaning fluid is contacted with a structure to be cleaned and produces a cleaning effluent, and adapted to generate a monitoring signal for transmission to a central processing unit arranged to receive the monitoring signal and produce an output to terminate the cleaning process in response to change in the monitoring signal indicating that the endpoint has been reached, said endpoint monitor comprising at least one of the following:
(a) a constant temperature probe adapted to be disposed in the cleaning effluent, and a power source operatively coupled with the constant temperature probe and adapted to variably supply power to the constant temperature probe in an amount maintaining the constant temperature probe at a predetermined temperature level, the power source providing said monitoring signal indicative of variable power supplied to the constant temperature probe in the cleaning effluent; and
(b) a radiation-emissive target adapted to be disposed in the cleaning effluent and to be thermally activated by the cleaning effluent to emit radiation, a window arranged to transmit emitted radiation from the target therethrough, and a radiation monitor arranged to receive emitted radiation transmitted through the window, the radiation monitor providing said monitoring signal indicative of a radiation emitted by the target.

133. The endpoint monitor of claim 132, comprising a constant temperature probe adapted to be disposed in the cleaning effluent, and a power source operatively coupled with the constant temperature probe and adapted to variably supply power to the constant temperature probe in an amount maintaining the constant temperature probe at a predetermined temperature level, the power source providing said monitoring signal indicative of variable power supplied to the constant temperature probe in the cleaning effluent.

134. The endpoint monitor of claim 132, comprising a radiation-emissive target adapted to be disposed in the cleaning effluent and to be thermally activated by the cleaning effluent to emit radiation, a window arranged to transmit emitted radiation from the target therethrough, and a radiation monitor arranged to receive emitted radiation transmitted through the window, the radiation monitor providing said monitoring signal indicative of a radiation emitted by the target.

135. The endpoint monitor of claim 134, wherein the radiation monitor comprises an infrared pyrometer having a temperature operating range of from 25° C. to 200° C.

136. The endpoint monitor of claim 134, wherein the window is formed of a material selected from the group consisting of: sapphire, Group II metal fluorides, barium fluoride, calcium fluoride, and magnesium fluoride.

137. The endpoint monitor of claim 134, wherein the target is formed of a material selected from the group consisting of: metals, polymeric materials, and alloys, combinations, and composites of the foregoing.

138. The endpoint monitor of claim 132, operatively coupled to a central processing unit arranged to receive the monitoring signal and produce an output to terminate the cleaning process in response to change in the monitoring signal indicating that the endpoint has been reached.

139. The endpoint monitor of claim 138, wherein the central processing unit is operatively adapted to transmit the output to an actuator of a flow control valve through which the cleaning fluid is flowed to the cleaning process, for closure of the flow control valve.

140. The endpoint monitor of claim 132, as deployed in a semiconductor manufacturing facility.

141. The endpoint monitor of claim 140, in which the cleaning fluid comprises plasma-generated cleaning species.

142. The endpoint monitor of claim 140, in which the cleaning fluid comprises fluoro species.

143. The endpoint monitor of claim 140, wherein the structure to be cleaned comprises a semiconductor manufacturing process tool.

144. The endpoint monitor of claim 132, wherein the structure to be cleaned comprises an enclosure.

145. The endpoint monitor of claim 140, wherein the semiconductor manufacturing process tool comprises a deposition chamber adapted to perform at least one deposition process selected from the group consisting of: physical vapor deposition, sputtering, electrolytic deposition, chemical vapor deposition, ion implantation, and plasma deposition.

146. The endpoint monitor of claim 145, wherein the deposition chamber is coupled with a source of process gas for deposition processing of a semiconductor article, and the deposition chamber is coupled with a source of said cleaning fluid for said cleaning process.

147. The endpoint monitor of claim 146, wherein said central processing unit is adapted to carry out a cycle in which said deposition processing and said cleaning process are carried out in alternating sequence.

148. A cleaning process comprising:
contacting a cleaning fluid with a structure to be cleaned and producing a cleaning effluent having a sensible heat calorimetric energy characteristic corresponding to extent of cleaning of said structure,
disposing an object in the cleaning effluent that interacts with the cleaning effluent to produce a response indicative of the sensible heat calorimetric energy characteristic of the cleaning effluent, and
monitoring said response to determine when said cleaning is completed.

149. The cleaning process of claim 148, wherein said response comprises emissivity of said object.

150. The cleaning process of claim 148, wherein said object comprises a constant temperature probe adapted to draw power from a power supply in an amount necessary to maintain a predetermined temperature level, and wherein said response comprises change in power draw from said power supply.

151. The cleaning process of claim 148, further comprising terminating said contacting upon determining that said cleaning is completed.

152. The cleaning process of claim 151, wherein said contacting is terminated by termination of flow of said cleaning fluid from a source thereof to said structure.

153. The cleaning process of claim 148, wherein said cleaning fluid comprises plasma-generated cleaning species.

154. The cleaning process of claim 153, wherein the plasma-generated cleaning species are generated from nitrogen trifluoride.

155. The cleaning process of claim 148, in which the cleaning fluid comprises fluoro species.

156. The cleaning process of claim 148, wherein the structure to be cleaned comprises an enclosure.

157. The cleaning process of claim 148, wherein the structure to be cleaned comprises a semiconductor manufacturing process tool.

158. The cleaning process of claim 157, wherein the semiconductor manufacturing process tool comprises a deposition chamber adapted to perform a deposition process selected from the group consisting of: physical vapor deposition, sputtering, electrolytic deposition, chemical vapor deposition, ion implantation, and plasma deposition.

159. The cleaning process of claim 158, wherein the deposition chamber is coupled with a source of process gas for deposition processing of a semiconductor article, and wherein the deposition chamber is coupled with a source of said cleaning fluid for said cleaning.

160. The cleaning process of claim 159, comprising use of a central processing unit to carry out a cycle in which said deposition processing and said cleaning process are carried out in alternating sequence.

161. A method of conducting a cleaning process utilizing a cleaning fluid and producing a cleaning effluent whose calorimetric character corresponds to an extent of completion of said cleaning process, said method comprising monitoring variation of a cleaning process variable that is a function of the calorimetric character of the cleaning effluent, and terminating said cleaning process in response to change of said cleaning process variable indicative of completion thereof.

162. The method of claim 161, wherein said cleaning process is conducted to clean a chamber in which deposits have accumulated during prior use thereof, wherein said chamber is adapted to perform at least one deposition process selected from the group consisting of: physical vapor deposition, sputtering, electrolytic deposition, chemical vapor deposition, ion implantation, and plasma deposition.

163. A method of determining endpoint of a cleaning process in which a cleaning medium is contacted with a surface or structure to be claimed, and produces an effluent, said method comprising monitoring an energetic characteristic of the effluent indicative of progress of cleaning to determine said endpoint of the cleaning process.
